(19) United States
(12) Patent Application Publication
(10) Pub. No.: US 2026/0051527 A1
(43) Pub. Date: Feb. 19, 2026

(54) MODULAR DRY ROOM SYSTEM FOR BATTERY PROCESSING AND SYSTEMS AND METHODS OF THE SAME

(71) Applicant: Ampcera Inc., Tucson, AZ (US)

(72) Inventors: Hui Du, Tucson, AZ (US); James Emery Brown, Tucson, AZ (US); Eongyu Yi, Tucson, AZ (US); Sumin Zhu, Tucson, AZ (US)

(21) Appl. No.: 19/302,317

(22) Filed: Aug. 18, 2025

Related U.S. Application Data
(60) Provisional application No. 63/684,243, filed on Aug. 16, 2024.

(51) Int. Cl. H01M 10/04; H01M 10/058

(52) U.S. Cl. CPC H01M 10/0404; H01M 10/058

(57) ABSTRACT

A modular dry room system comprising: a processing module configured to perform one or more moisture-sensitive processes; and a control module physically separate from and operatively connected to the processing module, wherein the control module is configured to monitor and regulate environmental conditions within the processing module.

### PRIORITY

This application claims the benefit of U.S. Provisional Patent Application No. 63/684,243, filed Aug. 16, 2024, the entire contents of which are hereby incorporated by reference herein.

### FIELD

The present description relates to dry room systems and methods for next-generation battery processing.

### BACKGROUND

Commercialization of next-generation batteries, particularly sulfide-based solid-state batteries, is inhibited by a lack of processing capabilities owing to the low dew points requirements. Traditional lithium batteries are processed at ambient conditions with only specific sections of the manufacturing line being dry or inert, such as liquid electrolyte filling, keeping manufacturing costs low. However, next-generation batteries require most if not all the manufacturing line to be under a low dew point, for example, −40° C., requiring a dry room. But conventional dry rooms have high capital investment and operating costs making it challenging for scale-up processing. Moreover, matching dry room size with the proper processing equipment is tedious and often results in too much unoccupied or unutilized space, increasing operating costs.

Historically, dry rooms have been constructed using conventional “stick-built” methods, wherein framing, insulation, vapor barriers, and interior finishes are installed piece-by-piece on-site. This approach allows for customized layouts but requires significant time, coordination, and labor, and often suffers from inconsistent sealing performance—particularly at joints, penetrations, and corners—making it difficult to achieve and maintain ultra-low dew points throughout the space. Stick-built dry rooms are also permanently fixed to the building structure and are not easily modified or relocated if production needs change.

To improve construction efficiency and environmental reliability, many dry rooms today are built from prefabricated insulated panels that are assembled on-site. These “panelized” dry rooms offer better sealing and faster installation compared to stick-built methods and are widely used in battery processing. However, the resulting structure is still typically custom-built for a particular facility layout and integrated with permanent HVAC, gas handling, and electrical systems. Once assembled, panelized dry rooms are essentially fixed installations, and they still require careful matching of room dimensions to the equipment footprint. When production needs change, the cost of reconfiguring or relocating such rooms is substantial, and the environmental control systems must be recalibrated or redesigned, limiting scalability and flexibility.

More recently, prefabricated volumetric cleanroom “pods” have been introduced to reduce installation time and provide a more modular solution. These pod-style systems are constructed and sealed at the factory and delivered as fully integrated units containing HVAC, filtration, and utility connections. Once placed on-site and connected to external utilities, they can achieve low dew point operation without the need for on-site assembly of walls or air handling systems. While this approach improves mobility and deployment speed, the control systems are typically integrated into the same physical enclosure as the dry working volume, limiting the ability to independently scale, reposition, or reuse the environmental control components across different processing modules or lines.

Accordingly, there remains a need for modular dry room systems that provide improved flexibility, reduced installation cost, and better alignment between environmental control capacity and processing equipment layout. In particular, there is a need for dry room architectures that physically separate the processing environment from the environmental control systems—such that both components can be prefabricated, transported, and connected as modular units, enabling efficient deployment, scale-up, and reconfiguration in dynamic processing environments such as battery production and battery disassembly.

### SUMMARY

According to a present description, there is a modular dry room system. In an example, the modular dry room system comprises: a processing module; and a control module connected to the processing module, wherein the control module is configured for controlling operations and regulating the working environment within the processing module. The modular dry room system may be designed to provide a turnkey, prefabricated solution for ultra-low dew point processing environments, particularly those required for next-generation batteries such as sulfide-based solid-state batteries. The processing module may be a hermetically sealed enclosure configured to maintain a controlled humidity environment, while the control module houses environmental regulation systems including dryers, chillers, filtration units, dehumidifiers, and power distribution components. The modular architecture allows the system to be transported as discrete units and rapidly deployed, integrated, or reconfigured at a processing site, without the need for traditional stick-built or panelized construction. The control module may further manage airflow between modules via dedicated supply and return ducts and may be electrically connected to power and control the processing equipment housed within the processing module. This physical and functional separation of processing and environmental control enables flexible scaling, efficient maintenance, and operational adaptability in dynamic production environments.

According to a present description, there is a method of installing a modular dry room system. In an example, the method of installing a modular dry room system comprises providing a processing module and connecting a control module to the processing module, wherein the control module is configured for controlling operations and regulating the working environment within the processing module. The method may further comprise prefabricating the processing module and the control module at an off-site facility, wherein each module is assembled, sealed, and equipped with internal systems prior to delivery. The prefabricated modules may be transported to the installation site using standard flatbed trailers, railcars, or other transport vehicles, with module dimensions tailored to conform to transportation constraints. Upon arrival, the modules may be offloaded, positioned, and operatively connected via preconfigured mechanical and electrical interfaces. These connections may include dedicated air supply and return ducts, power conduits, communication lines, and environmental control interfaces, allowing for rapid deployment without extensive on-site construction or calibration. This method enables fast, scalable, and repeatable deployment of ultra-low dew point dry room environments across diverse processing settings.

According to a present description, there is a method for manufacturing a battery, the method comprising providing a processing module and a control module connected to the processing module, regulating the working environment within the processing module using the control module, and controlling operations within the processing module using the control module to manufacture a battery. Following installation and interconnection of the prefabricated modules, the method may further comprise initiating operation of the environmental control systems within the control module, including activation of dryers, dehumidifiers, chillers, and air circulation components to achieve and maintain a target dew point—typically below −40° C.—within the processing module. Once the environmental conditions are stabilized, manufacturing operations may proceed within the sealed processing module, which may house equipment for slurry mixing, coating, calendering, stacking, welding, or other battery fabrication steps depending on whether a wet-based or dry-based process is employed. The control module may further monitor and adjust internal parameters such as temperature, humidity, pressure differentials, and particulate levels in real time to ensure a stable and contamination-free environment during the manufacturing process. In some examples, additional systems—such as solvent vapor recycling or hydrogen sulfide neutralization—may be operated and regulated by the control module to maintain worker safety and process integrity. The method enables rapid transition from module installation to high-specification battery processing in a controlled, reconfigurable environment.

Other embodiments of the disclosed systems and methods will become apparent from the following detailed description, the accompanying drawings and the appended claims.

### BRIEF DESCRIPTION OF THE DRAWINGS

FIG. 1 is a schematic representation of a perspective view of an exemplary modular dry room system according to the present description, including a control module and a processing module.

FIG. 2 is a schematic representation of the modular dry room system of FIG. 1 showing an interior of the processing module.

FIG. 3A is a schematic representation of a two-roller calendering system for dry battery processing.

FIG. 3B is a schematic representation of a four-roller calendering system for dry battery processing.

FIG. 3C is a schematic representation of a multi-roll calendering system for dry battery processing.

FIG. 4 is a schematic representation of a solid-state battery.

FIG. 5 is a schematic representation of a solid-state lithium metal battery.

FIG. 6 is a schematic representation of a solid-state anodeless battery.

FIG. 7 is a schematic representation of a lithium battery.

### DETAILED DESCRIPTION

The present description relates to a modular dry room systems and methods as a turnkey solution for next-generation battery processing, and, in particular, for sulfide-based solid-state batteries which require low dew points (−40° C. and lower) throughout the entire process. These modular systems provide a prefabricated, transportable, and rapidly deployable clean environment capable of supporting high-specification battery production with minimal on-site construction or calibration.

The present description further relates to a modular dry room system and method for wet-based processing of next-generation batteries, particularly sulfide-based solid-state battery processing. In such processes, liquid-phase binders or solvents may be used during electrode preparation or electrolyte integration, necessitating robust environmental controls to prevent moisture contamination and to safely manage solvent vapor accumulation and recovery. The modular system may be configured to incorporate solvent-safe construction materials, integrated vapor handling, and fire-suppression systems adapted for volatile compounds.

The present description further relates to a modular dry room system and method for dry-based processing of next-generation batteries, particularly sulfide-based solid-state battery processing. Dry-based processes may include dry electrode fabrication techniques such as solvent-free mixing, pressing, calendering, or hot lamination, where the risk of moisture ingress remains critical due to the hygroscopic nature of sulfide electrolytes. The modular system is capable of maintaining stable, ultra-low humidity conditions across all stages of dry processing to ensure material stability, interfacial integrity, and consistent electrochemical performance.

The modular dry room system of the present description may be customized and outfitted with the necessary processing equipment for any next-generation battery technology before customer delivery. Equipment may include electrode fabrication lines, electrolyte integration stations, cell assembly tools, or automation modules. Customization may be performed at the factory prior to shipment, enabling plug-and-play installation at the customer's facility with minimal integration time, and allowing end-users to commence production rapidly without the need for specialized cleanroom construction or retrofitting.

In a first embodiment of the present description, a modular dry room system is a turnkey solution for next-generation battery processing, particularly sulfide-based solid-state battery processing, comprising two separate modules: a control module and a processing module, each prefabricated and sealed prior to delivery.

In an aspect of the first embodiment, the control module is operatively connected to the processing module and is configured to manage both environmental regulation and operational control. The control module may include integrated systems such as desiccant or refrigeration-based dryers, chillers, HEPA filtration, Wi-Fi-enabled monitoring and control systems, smoke or gas detection units, and an electrical interface for supplying and regulating power to equipment within the processing module. Environmental sensors may enable real-time monitoring of temperature, dew point, and pressure differentials.

In another aspect of the first embodiment, the processing module is defined as a hermetically sealed enclosure configured to maintain ultra-low humidity and particle-controlled conditions suitable for sensitive battery processing processes. The enclosure may be constructed with vapor-tight seals, insulated structural panels, and pressure-controlled access points to minimize air ingress.

In another aspect of the first embodiment, the processing module is designed to maintain an internal dew point in the range of −30° C. to −90° C., with a preferred operational dew point below −50° C. These environmental conditions are important for preventing degradation of moisture-sensitive components such as sulfide-based solid electrolytes and lithium metal.

In another aspect of the first embodiment, the processing module houses equipment and tooling necessary for the fabrication of next-generation batteries, particularly sulfide-based solid-state batteries. This may include machinery for electrode mixing, coating, drying, calendering, stacking, welding, electrolyte deposition, and cell packaging, depending on the process flow selected by the end-user.

In another aspect of the first embodiment, the processing module includes a walk-in antechamber that functions as a buffer zone between the ambient environment and the main working area. The antechamber may be separately regulated by the control module and configured to purge incoming air with low-dew-point gas (e.g., dry nitrogen or recirculated conditioned air) upon personnel entry, thereby reducing moisture ingress and maintaining pressure differentials.

In another aspect of the first embodiment, the modular dry room system may be delivered to the customer site in a fully assembled state, with all specified processing equipment pre-installed and qualified within the processing module. Both the control and processing modules may be transported via flatbed trailer, railcar, or equivalent conveyance, and may be equipped with wheels, skids, or forklift channels to enable efficient unloading and repositioning within a customer facility.

In another aspect of the first embodiment, the system may be expanded by coupling one or more additional processing modules to an existing modular dry room system. Each additional processing module may include its own dedicated control module or may be integrated into the environmental and operational control systems of the existing control module, depending on system configuration. The exterior interface of the processing module—particularly around the antechamber entry point—may be specifically designed to accommodate expansion while preserving hermetic sealing, inter-module air handling compatibility, and environmental integrity.

In a second embodiment of the present description, a modular dry room system is configured as a turnkey solution for wet-based processing of next-generation batteries, particularly sulfide-based solid-state batteries. The system includes a processing module equipped with process-specific equipment for producing battery components such as cathodes, anodes, and solid-state electrolyte membranes under ultra-low dew point conditions. In the case of sulfide-based solid-state batteries, the system may support production of moisture-sensitive composite cathodes, composite anodes, and interfacial solid-state electrolyte layers. The modular dry room system may be tailored to perform only those processing steps requiring strict humidity control—such as component preparation—while final battery assembly may occur in a separate zone or facility. Alternatively, the system may be configured to support end-to-end fabrication of fully assembled battery cells within the sealed environment of the processing module.

In an aspect of the second embodiment, the processing module may include integrated or modularly arranged equipment for wet-based electrode fabrication and cell assembly processes. For example, equipment may include one or more vacuum slurry mixers for homogenizing cathode or anode materials with liquid-phase binders or solvents; one or more slurry coaters for applying the mixed slurries onto metal current collectors; one or more drying ovens for solvent removal; one or more hot calendering rollers for densification; and one or more slitters for trimming electrode sheets. Additional downstream equipment may include secondary drying ovens, electrode notching or shaping stations, and tools for stacking, winding, and welding electrode layers into cell configurations. While critical processes may be housed within the processing module to maintain environmental control, supplementary equipment may be positioned externally and interfaced through sealed feedthroughs or transfer ports, depending on the desired level of process integration.

In another aspect of the second embodiment, the processing module may be equipped with a solvent vapor management system to capture, recycle, or neutralize volatile organic compounds (VOCs) generated during wet-based processing. In an example, air within the processing module may be actively extracted and directed through a secondary recycling system, located either within or external to the module. This system may condense and recover solvent vapors through refrigeration or adsorption-based condensation, separating the vapors from the air stream. The recovered air—once purified—may be returned and backfilled into the processing module to maintain pressure balance and reduce environmental burden. Alternatively, the extracted air may be exhausted and replaced with fresh, dehumidified air without reintroduction. Operation of the vapor recovery and recycling system may be regulated by the control module, which monitors solvent concentrations, dew point, and airflow rate to ensure safe and efficient operation.

In yet another aspect of the second embodiment, the processing module may include a hydrogen sulfide (H₂S) neutralization system to ensure a safe working environment when processing sulfide-containing materials. In an example, contaminated air within the processing module may be circulated through a secondary neutralizing unit, which may include a heated reactive mesh or filtration element—such as copper mesh—that chemically binds or decomposes H₂S gas. The resulting filtered air may be recirculated back into the module or safely vented, depending on system design. The neutralizing system may be implemented as a standalone unit within the processing module or as an external treatment system operatively connected via ductwork. The control module may monitor H₂S levels using gas sensors and automatically activate or modulate the neutralization system in response to detected concentrations, ensuring compliance with safety thresholds and occupational exposure limits.

In a third embodiment of the present description, a modular dry room system is configured as a turnkey solution for dry-based processing of next-generation batteries, particularly sulfide-based solid-state batteries. The system includes at least one processing module that may be equipped with process-specific machinery suitable for solvent-free fabrication of battery components under ultra-low humidity conditions. Such components may include composite cathodes, composite anodes, and solid-state electrolyte membranes. The system is designed to maintain stringent environmental controls—such as dew points below −40° C.—to preserve the chemical and structural integrity of moisture-sensitive materials. The modular dry room system may be configured to process only the critical moisture-sensitive components, with subsequent assembly performed elsewhere, or may alternatively support the complete fabrication of integrated battery cells within the controlled environment of the processing module.

In an aspect of the third embodiment, dry-based processing may be employed to produce freestanding battery components, which are self-supporting structures not initially laminated onto a current collector. This approach is particularly advantageous for next-generation designs seeking high energy density, simplified layering, or novel stacking configurations. The fabrication process for such freestanding components may comprise four sequential stages: (Stage #1) Material Homogenization, (Stage #2) Three-Dimensional (3D) Fibrosis Mixing, (Stage #3) Omnidirectional Film Deposition, and (Stage #4) Hot Calender Rolling. These stages are designed to transform dry powders and binding polymers into mechanically robust, electrochemically active films suitable for integration into solid-state battery architectures.

In another aspect of the third embodiment, the material homogenization stage (Stage #1) involves the thorough and uniform mixing of dry material components to ensure consistent dispersion, prevent agglomeration, and establish the foundational microstructure of the final battery component. Material components may include active electrode particles—such as lithium nickel manganese cobalt oxide (NMC), lithium iron phosphate (LFP), or lithium titanate (LTO) for cathodes or anodes—along with electronically conductive additives (e.g., carbon black, carbon nanotubes), high-molecular-weight binding polymers (e.g., polytetrafluoroethylene or PVDF), and solid-state ionic conductive ceramics (e.g., lithium lanthanum zirconate (LLZO), lithium phosphorus oxynitride (LiPON), or argyrodite-type sulfides like Li₆PS₅Cl). The homogenization process aims to create a dry, flowable blend with precise control over particle distribution, interfacial contact potential, and binder dispersion. This may be accomplished using one or more mixing devices such as benchtop mixers for small-batch precision, V-mixers for uniform blending of free-flowing powders, vertical or horizontal mills for intensive shear mixing, or roller mills for controlled particle size reduction and surface activation. The output of this stage is a homogenous dry mixture suitable for advanced structuring in subsequent stages.

In yet another aspect of the third embodiment, the three-dimensional (3D) fibrosis mixing stage (Stage #2) is performed to mechanically stretch and elongate the binding polymers within the homogenized dry mixture, transforming them into fibrillar networks that provide enhanced structural cohesion. This process is particularly important for high-molecular-weight binders such as polytetrafluoroethylene (PTFE), which do not melt or dissolve under typical processing conditions. Under shear and compressive forces—such as those introduced through high-energy mixing, extrusion, or directional rolling—the PTFE particles undergo fibrillation, forming elongated polymer filaments with high surface area and entanglement potential. These fibrous structures serve as a mechanical scaffold that interlocks the active materials and conductive additives, thereby enhancing the mechanical integrity, flexibility, and resilience of the resulting electrode or separator component. The 3D distribution of filaments also improves particulate retention and accommodates differential thermal expansion during subsequent processing or cycling, making the component more durable under real-world operating conditions. The fibrosis mixing stage may be tailored to control filament density, orientation, and length scale, depending on the specific application and targeted electrochemical properties.

In yet another aspect of the third embodiment, the omnidirectional film deposition stage (Stage #3) is performed to form a uniform, fibrous composite film in which the previously generated polymer filaments—such as fibrillated PTFE—are distributed in a multidirectional, interwoven network throughout the material matrix. This stage may involve spreading, pressing, or molding the fibrillated dry mixture onto a flat or contoured surface, with controlled compression or compaction applied to lock the fibrous structures into place without aligning them in any single preferred direction. The omnidirectional distribution of filaments enhances mechanical isotropy, meaning the resulting film exhibits similar toughness and strength in all planar directions, reducing the risk of cracking or delamination under flexural or thermal stress. This multidirectional reinforcement network significantly increases the toughness, tear resistance, and dimensional stability of the battery component-whether it functions as an electrode, solid electrolyte membrane, or hybrid separator. Additionally, this structure improves handling robustness during downstream processing (e.g., lamination, winding, or stacking) and may enhance interfacial compliance during cell cycling, contributing to the long-term reliability of the battery.

In yet another aspect of the third embodiment, the hot calender rolling stage (Stage #4) is used to thermally activate and mechanically compact the omnidirectionally structured composite film formed in the previous stage. During this process, the polymer filaments—particularly fibrillated PTFE—are softened under elevated temperatures, allowing them to fuse partially with adjacent material domains and establish strong cohesive bonds throughout the structure. Concurrently, the homogenized dry materials—comprising active electrode particles, conductive additives, and solid electrolytes—are densified through applied pressure, reducing porosity and enhancing physical contact between constituents. This densification improves electronic and ionic conduction pathways, minimizes interfacial resistance, and increases volumetric energy density.

The hot calendering operation may be carried out using a single heated roller or a series of rollers arranged in tandem, depending on the desired degree of densification and the targeted production scale. For example, a two-roller system may be suitable for small-scale research and development or prototyping, while a four-roller system may serve pre-pilot or early validation runs. For commercial-scale manufacturing, multi-roller calendering systems—capable of continuous operation and precise thickness control—may be implemented to support high-throughput production of freestanding electrodes or solid-state electrolyte sheets. Roll temperature, pressure, and line speed may be dynamically controlled via the control module to ensure repeatable film quality and structural consistency.

In yet another aspect of the third embodiment, all remaining steps in battery processing—beyond the formation of freestanding components—may be conducted either externally to the processing module, within the same processing module, or within a separate, dedicated processing module connected to the overall system. This modular architecture allows the manufacturing process to be segmented or integrated based on customer needs, facility constraints, or production volume targets.

Such remaining steps may include, for example, lamination of freestanding electrodes or solid-state electrolyte sheets onto metallic current collectors, precision slitting or trimming of electrodes to desired widths, notching or shaping of electrodes to facilitate stacking or winding, and layer-by-layer assembly of full cells using stacking or jelly-roll winding methods. Additional steps may comprise ultrasonic or laser welding of tabs and terminals, cell packaging (e.g., pouching or casing), electrolyte infusion or interface coating (if applicable), and final dry room sealing or preconditioning steps prior to transfer to formation and testing stations. The flexible deployment of these steps within or across modules enables scalable and reconfigurable manufacturing lines, supporting both pilot-scale development and high-throughput production.

In yet another aspect of the third embodiment, the processing module may include an integrated or external system for neutralizing hydrogen sulfide (H₂S) gas, thereby ensuring a safe and compliant working environment during the dry-based processing of sulfide-containing materials, such as argyrodite or thiophosphate-based solid electrolytes. Exposure to H₂S, even at low concentrations, poses health and safety risks and may trigger regulatory thresholds for indoor air quality.

To mitigate this risk, air within the processing module may be continuously or intermittently circulated through a secondary neutralizing system, which may be positioned either inside the module or externally connected via sealed ductwork or interface ports. In an example, the neutralizing system comprises a heated reactive metal mesh, such as copper or copper oxide, which chemically binds with H₂S gas through surface reactions to form non-volatile copper sulfide compounds. This process removes hydrogen sulfide from the circulating air, allowing the purified air to be either recirculated and backfilled into the module or safely exhausted, depending on the design.

The neutralizing system may include temperature control, airflow regulation, and gas concentration sensors, and may be regulated by the control module to ensure automated response to fluctuating H₂S levels. This configuration enables continuous compliance with occupational exposure limits (e.g., OSHA, NIOSH, or international equivalents), while preserving the sealed, ultra-low dew point environment required for high-performance dry-based battery processing.

In a fourth embodiment of the present description, a modular dry room may be used to manufacture next-generation batteries, particularly sulfide-based solid-state batteries.

In an aspect of the fourth embodiment, a next-generation battery may comprise an anode formed or laminated onto a negative current collector, a cathode formed or laminated onto a positive current collector, a separator used to physically separate the anode from the cathode, an electrolyte as an ion-conducting medium with the battery, and outer battery packaging.

In another aspect of the fourth embodiment, an electrolyte may be a liquid, an ionic liquid, a polymer, a gel polymer, a solid-state ionic conducting ceramic, an ionic conducting ceramic-polymer composite, or a combination thereof.

In yet another aspect of the fourth embodiment, a sulfide-based solid-state battery may comprise a composite anode, comprising a solid-state ionic conducting material known in the art as an anolyte, formed or laminated onto a negative current collector, a composite cathode, comprising a solid-state ionic conducting material known in the art as a catholyte, formed or laminated onto a positive current collector, a solid-state ionic conducting membrane separating the composite anode and composite cathode, and out battery packaging.

In yet another aspect of the fourth embodiment, a sulfide-based solid-state battery may comprise an alkali metal anode formed or laminated onto a negative current collector, a composite cathode, comprising a solid-state ionic conducting material known in the art as a catholyte, formed or laminated onto a positive current collector, a solid-state ionic conducting membrane separating the alkali metal anode and composite cathode, and out battery packaging.

In yet another aspect of the fourth embodiment, a sulfide-based solid-state battery may comprise a negative current collector, a composite cathode, comprising a solid-state ionic conducting material known in the art as a catholyte, formed or laminated onto a positive current collector, a solid-state ionic conducting membrane separating the negative current collector and composite cathode, and out battery packaging in what is known in the art as an anodeless solid-state battery.

In yet another aspect of the fourth embodiment, a sulfide-based solid-state electrolyte may be a solid-state ionic conductive material with the general formula Li₂ₓS_{x+w+5z}M_{y}P_{2z}, where x is 8-16, y is 0.1-6, w is 0.1-15, z is 0.1-3, and M is selected from the group consisting of lanthanides, Group 3, Group 4, Group 5, Group 6, Group 7, Group 8, Group 9, Group 12, Group 13, and Group 14 atoms, and combinations thereof.

In yet another aspect of the fourth embodiment, a sulfide-based solid-state electrolyte may be a solid-state ionic conductive material with the general formula Li₁₂₋ₘ₋ₓ(MₘY₄²⁻)Y₂₋ₓ²⁻Xₓ⁻, wherein M^{m+}=B³⁺, Ga³⁺, Sb³⁺, Si⁴⁺, Ge⁴⁺, P⁵⁺, As⁵⁺, or a combination thereof; Y²⁻=O²⁻, S²⁻, Se²−, Te²⁻, or a combination thereof; X⁻=F⁻, Cl⁻, Br⁻, I⁻, or a combination thereof; and x is in the range of 0≤x≤2.

In yet another aspect of the fourth embodiment, a sulfide-based solid-state electrolyte may be a solid-state ionic conductive material with the general formula Li₁₈₋₂ₘ₋ₓM₂^{m+}Y₍₉₋ₓ₎₊ₙXₓ, wherein M^{m+}=B³⁺, Ga³⁺, Sb³⁺, Si⁴⁺, Ge⁴⁺, P⁵⁺, As⁵⁺, or a combination thereof; Y²⁻=O²⁻, S²⁻, Se²⁻, Te²⁻, or a combination thereof; X⁻=F⁻, Cl⁻, Br⁻, I⁻, or a combination thereof; and x is in the range of 0≤x≤2.

Although reference is made to various embodiments of the present description, it will be understood that additional embodiments of the present description are included in the present description.

### DETAILED DESCRIPTION

The present description pertains to the first embodiment of the specification.

A modular dry room system is a turnkey solution for next-generation battery processing, particularly sulfide-based solid-state battery processing.

A modular dry room system comprises two separate modules: a control module and a processing module.

The present description pertains to the control module.

A control module may control all modular dry room system operations.

A control module may be connected to the processing module by a primary air-handling system that is responsible for controlling and regulating the working environment within the processing module. The air-handling system may comprise an air supply duct to the processing module and an air return duct to the control module. The control module may further comprise an air exhaust system and an air inlet system from the ambient environment.

A control module may be electrically connected to the processing module, wherein all power in the processing module is regulated through the control module.

A control module may be equipped with dryers, dehumidifiers, chillers, condensers, WIFI control, smoke alarms, and an electrical interface that is connected to the processing module to regulate the power supply.

A control module may regulate the environment within a walk-in antechamber or anteroom within the processing module using the primary air-handling system or a secondary air-handling system.

A control module is a single unit that can be described as a standalone room bigger than, smaller than, or the same size as the processing module.

While there are no defined size limits on the control module, it should be understood the dimensions of the control module may be limited to the means of delivery. For example, a standard flatbed trailer has the dimensions of 53 ft by 8.5 ft. Thus, a control module being delivered by a standard flatbed trailer may have a size around this or smaller. In another example, a flatbed railcar can have a length in the range of 60 to 90 feet. Thus, a control module being delivered by a flatbed railcar may have a maximum length within this range. Furthermore, it is understood that there are non-standard flatbed trailers, flatbed railcars, and other means of transportation that may enable control modules that are too large for standard means of delivery.

A control module may be delivered directly to the customer assembled with all functioning units affixed to the module. It's anticipated that the control module will be delivered to customers by a flatbed trailer or by rail. The control module may be on wheels to easily unload and maneuver within a manufacturing facility.

A control module may be connected directly to the power supply of the manufacturing facility. The control room may be equipped to handle voltage in the range of 110 to 1000 V for an alternating current or 110 to 1500 V for a direct current. A control module may further comprise one or more step-up transformers or step-down transformers.

A control module may have a main entry door with an emergency exit door on the opposite side of the entry door.

A control module may have one or more observational or viewing windows.

While a control module may comprise of multiple panels connected to form an outer shell, it's preferred that the control module be one continuous panel or wall connected to the adjacent panels or walls at the corners of the module.

While it is preferred that the control module sit adjacent to the processing module, it may also be positioned away from the processing module such as an alternative room within a manufacturing facility, outside the manufacturing facility comprising the processing module, or sit on top of the processing module itself.

A control module may also be placed outside the building comprising a processing module. A control module may be positioned at any location that allows for water and electricity connections. Alternatively, the water supply may be an isolated system separate from the control module.

A control module may be directly powered by a primary or backup generator, solar panels, wind turbine, geothermal, hydrothermal, redox flow batter, etc.

A control module may further comprise other components not essential to the operation of the processing module such as a bathroom (comprising a toilet, a sink, and a shower or tub), kitchenette, lounging area, and sleeping quarters.

The control module is a self-contained, self-sufficient unit responsible for managing the environmental and operational conditions of one or more processing modules. Its internal systems are designed to function independently from the processing module, ensuring that all control logic, air processing, and power regulation are handled outside the sealed manufacturing environment. This architecture enables strict isolation between environmental control infrastructure and production activities, thereby minimizing cross-contamination risk and preserving dew point stability.

The separation of the control module from the processing module also enables ease of installation and deployment, as the control system may be delivered pre-configured, tested, and ready for utility hookup. Once in place, the control module governs environmental and operational performance via defined interfaces—such as air ducts, electrical cables, and sensor lines—while remaining physically and functionally distinct.

By externalizing all environmental regulation and utility management to the control module, the system supports standardization of the processing module interior, allowing different processing module variants to be integrated without re-engineering the control infrastructure. This separation of responsibilities reinforces the modular, plug-and-play nature of the system and simplifies maintenance, replacement, and scalability over time.

The present description pertains to the processing module.

A processing module may be defined as a hermetically sealed environment designed to maintain low humidity levels and particle filtration.

A processing module may have a dew point in the range of −30 to −90° C., with a preferred dew point of less than −50° C.

A processing module may comprise the equipment used to processing next-generation batteries, particularly sulfide-based solid-state batteries.

A processing module may comprise a walk-in antechamber or anteroom that serves as a buffer room between the ambient environment and working space. Moreover, the control module may regulate the environment within the antechamber, flushing in dry air upon entry into the processing module. The antechamber or anteroom may be the main entrance into the processing module.

A walk-in antechamber or anteroom may comprise a small portion of the overall area of the processing module, preferably less than 50%, more preferably less than 40%, more preferably less than 30%, more preferably less than 20%, more preferably less than 10%, more preferably less than 5%.

A walk-in antechamber or anteroom has at least one entranceway leading outside the processing module and at least one entranceway leading inside the working area of the processing module.

A processing module may comprise more than one walk-in antechamber or anteroom.

A processing module may comprise more than one entranceway leading outside the processing module. Preferably, the entranceways face one another on opposite sides of the processing module to allow additional modular dry room systems to be connected.

A processing module may comprise of viewing or observational windows.

A processing module may comprise a pass box allowing materials or equipment to be quickly passed outside the module without needing to go through the antechamber or anteroom.

A processing module may comprise at least one emergency exit. An emergency exit may be a doorway or through a hatch on top of the module.

A processing module may comprise other components essential to the manufacturing process such as gas inlets. The gas supply may come from gas cylinders inside the processing module, gas cylinders inside the control module, or a separate gas supply system such as an external bulk or microbulk system.

A processing module may comprise other components essential to the manufacturing process such as electrical receptacles and disconnect boxes for power supply to the processing equipment. The power supply may be provided by the control module.

A processing module may comprise components not directly related to the manufacturing process such as lights, fire alarms, security systems, motion detectors, cameras, etc.

A processing module may comprise an indicator light on top when in use.

A processing module may be designed to allow only a limited number of people to enter while in use. The number may range from 1 to 20, with a preferred range of 1 to 5.

A processing module is a single unit that can be described as a standalone room bigger than, smaller than, or the same size as the control module.

A processing module may be delivered directly to the customer fully assembled with all processing equipment already affixed to and within the module. It's anticipated that the processing module will be delivered to customers by a flatbed trailer or by rail. The processing module may be on wheels so that they can be easily unloaded and maneuvered within a manufacturing facility.

While there are no defined size limits on the processing module, it should be understood the dimensions of the processing module may be limited to the means of delivery. For example, a standard flatbed trailer has the dimensions of 53 ft by 8.5 ft. Thus, a processing module being delivered by a standard flatbed trailer may have a size around this or smaller. In another example, a flatbed railcar can have a length in the range of 60 to 90 feet. Thus, a processing module being delivered by a flatbed railcar may have a maximum length within this range. Furthermore, it is understood that there are non-standard flatbed trailers, flatbed railcars, and other means of transportation that may enable processing modules that are two large for standard means of delivery.

While a processing module may comprise of airtight panels for an outer shell, it's preferred that the processing module be one continuous panel or wall connected to the adjacent panels or walls at the corners of the module.

A processing module may be used to manufacture next-generation battery components that are moisture-sensitive such as a solid-state ionic conductive material.

A processing module may be used to manufacture precursors for next-generation battery materials that are moisture-sensitive such as lithium sulfide.

A processing module may be used to manufacture non-battery-related materials such as foods or pharmaceuticals that happen to be moisture-sensitive.

A processing module may also be retrofitted to be both a humidity-controlled dry room and a clean room.

A processing module may be used to manufacture moisture-sensitive thin films for both battery and non-battery applications.

As described above, the processing module is physically and functionally distinct from the control module, serving as the primary site for production operations while relying on the control module for environmental conditioning and power regulation. This separation allows the processing module to maintain a hermetically sealed and contamination-minimized environment, optimized for the fabrication of moisture-sensitive materials, without incorporating the full complexity of environmental control systems within the module itself.

The modular separation of production from control allows for standardization across multiple processing modules, all of which may be serviced by a common control architecture. This approach facilitates scalable deployment, where additional processing modules can be connected to an existing system without the need for duplicating infrastructure.

The processing module is thus optimized for turnkey delivery, rapid deployment, and repeatable performance, whether as part of a pilot-scale setup or a large-scale production line. By externalizing air handling, power management, and environmental regulation to the control module, the processing module can preserve internal space for production equipment, minimize internal complexity, and streamline cleaning and maintenance procedures.

This physical and operational decoupling of manufacturing and control functions reflects the core architecture of the modular dry room system, enabling a clean, controlled, and mobile production space that can be deployed quickly, scaled easily, and maintained independently of its supporting infrastructure.

In addition to manufacturing battery components or precursors, the processing module can also be configured for other active operations carried out under controlled environmental conditions. Such operations may include assembly of battery components into complete cells or packs, disassembly of cells or packs for analysis, recovery, or recycling, refurbishment or repair of components, research and development work involving experimental materials or architectures, and testing or conditioning of cells, components, or materials. These activities may be performed at laboratory, pilot, or production scale, using the same modular architecture and environmental controls described herein.

The present description pertains to the modular dry room system.

A modular dry room system comprises the control module and the processing module connected by an air handling system and power distribution.

A modular dry room system may sit inside a manufacturing plant with a sufficiently large enough room, or rooms in the event they are not adjacent to one another, or outside. If sitting outside, they may be at a location that provides water hookup (or a water supply) and sufficient power.

A modular dry room system may be assembled with all functioning units and processing equipment affixed to the respective module. It's anticipated that the modular dry room system will be delivered to customers by flatbed trailers or by rail. The modular dry room system may be on wheels to easily unload and maneuver within a manufacturing facility.

A modular dry room system may be designed in such as way as to allow additional modular dry room systems to be connected in order to expand battery processing capabilities. In such instances, each processing module may have its own control module are share a control module with a processing module. Typically, the processing modules would be connected at the entranceway leading to the antechamber or anteroom. While adjacent processing modules may be directly connected at the entranceway, there can also be a standalone hermetically sealed hallway, or a secondary antechamber/anteroom, positioned between the entranceway of the adjacent processing modules.

A modular dry room system may be assembled in such a way to allow it to operate while mobile such as on small, medium, or large shipping vessels, on a large cargo plane, flatbed trailers, railways, etc.

A modular dry room system may be assembled in such a way to allow it to operate as a stand-alone system in non-traditional locations (i.e., non-manufacturing or industrial plant) such as on the street, in an empty lot, on top of a building, urban areas, non-urban areas, on a farm, in the wilderness, on a beach, etc.

While there are no defined size limits on the modular dry room system, it should be understood the dimensions of the manufacturing and control module may be limited to the means of delivery. For example, a standard flatbed trailer has the dimensions of 53 ft by 8.5 ft. Thus, manufacturing and control modules being delivered by at least one standard flatbed trailer may have a size around this or smaller. In another example, a flatbed railcar can have a length in the range of 60 to 90 feet. Thus, manufacturing and control modules being delivered by a flatbed railcar may have a maximum length within this range. Furthermore, it is understood that there are non-standard flatbed trailers, flatbed railcars, and other means of transportation that may enable manufacturing and control modules that are too large for standard means of delivery. It is further understood that the manufacturing and control modules may be delivered using flatbed trails or railcars, wherein each module has its own means of delivery.

Furthermore, it is understood that all air handling and power connections between the two modules may be accomplished post-delivery to the customer.

As described herein, the modular dry room system is distinguished by its dual-module architecture, wherein environmental control and manufacturing operations are physically and functionally separated, yet operate in a coordinated manner through defined connections for air handling, power, and process control. This separation allows each module to be individually optimized, whether for transportation, on-site placement, environmental integrity, or operational flexibility.

The modular dry room system enables scalable deployment models, from a single control-manufacturing pair to multi-module arrays supporting parallel or sequential production lines. Because each module is pre-assembled, self-contained, and transportable, the system reduces on-site construction time, improves quality control, and enables rapid installation across diverse settings-including traditional industrial plants, urban rooftops, remote field operations, or mobile platforms.

By centralizing regulation functions in the control module and isolating production in the processing module, the system supports a plug-and-play configuration, in which equipment, utilities, and environmental conditions are standardized across different deployments. This architecture facilitates maintenance, equipment upgrades, and future-proofing while preserving the controlled conditions required for sensitive battery or materials manufacturing.

The modular dry room system thus represents a turnkey, flexible, and relocatable manufacturing platform, designed to meet the increasing demands of next-generation battery production and other moisture-sensitive fabrication processes, while maintaining compliance with environmental and safety standards in a wide range of deployment contexts.

The present description pertains to the second embodiment of the specification.

A modular dry room system is a turnkey solution for wet-based processing of next-generation batteries, particularly sulfide-based solid-state battery processing.

The present description pertains to wet-based processing equipment comprised within the processing module.

A processing module may comprise the necessary equipment for wet-based processing of next-generation batteries and battery components (i.e., cathodes and anodes). In the case of solid-state batteries, components may include a composite cathode, a composite anode, and a solid-state electrolyte membrane.

The modular dry room system may be designed to manufacture only the components that are moisture sensitive whereas the remaining processes for battery assembly are done outside the processing module. Alternatively, the entire battery cell manufacturing process may take place inside the manufacturing model such as in the case of a sulfide-based solid-state battery.

Processing equipment for wet-based processing may include one or more vacuum slurry mixers that are used to form a homogenous slurry comprising a solvent and battery materials (cathode, anode, binder, electronically conductive additives, and solid-state ionic conductive materials as in the case of solid-state batteries). A vacuum is pulled on the solvent to remove air bubbles to ensure uniform coating. The solvent may include, for example, N-Methyl-2-pyrrolidone, toluene, butyl butyrate, cyclohexane, xylene, etc. A slurry mixture may also include a surfactant. The one or more vacuum slurry mixtures may range in size from a benchtop unit, for example, 1-5 L, affixed to a lab bench affixed to the processing module, or a standalone industrial scale unit, for example, >5 L, affixed directly to the processing module floor. The slurry mixture may be transported to a slurry coater manually or through the use of automation/robotics.

Processing equipment for wet-based processing may include one or more slurry coaters, post-slurry mixing, used to form a slurry-coated film onto a substrate. A substrate may include, for example, a positive or negative current collector, a fabric support, mylar, or polytetrafluoroethylene (i.e., Teflon). In the case of a solid-state battery, a substrate may include a composite anode, alkali metal film, or a composite cathode, wherein the slurry comprises a solid-state ionic conductive material used to form a solid-state electrolyte membrane. The slurry coating equipment may be roll-to-roll used to coat a uniform slurry on a substrate with a width in the range of 1≤w≤48 inches, with a preferred range of 2≤w≤12 inches. A slurry coating technique may include, for example, gravure printing, inkjet, slurry casting, doctor blade casting, spraying, knife-over-edge coating, dip coating, slot-die coating, etc. The one or more slurry coaters may range in size from a benchtop unit, affixed to a lab bench affixed to the processing module, or a standalone industrial scale unit, affixed directly to the processing module floor

Processing equipment for wet-based processing may include one or more dry ovens, and post-slurry coating, wherein the substrate, comprising the slurry-coated film, is rolled through the oven system to remove the solvent. Oven temperatures may be in the range of 25 to 300° C. Solvent may be evaporated, condensed, and reused. The one or more drying ovens may have a vacuum system that pulls away evaporated solvent. A solvent recycling system may be positioned inside the processing module or external to the processing module. The one or more drying ovens may range in size from a benchtop unit, affixed to a lab bench affixed to the processing module, or a standalone industrial scale unit, affixed directly to the processing module floor

Processing equipment for wet-based processing may include one or more hot calender rolling units, post oven drying, used to densify the dry-coated film. Briefly, the substrate, comprising the coated film, is rolled through two hot rollers (with a gap distance sufficient for both the substrate and film to roll through) used to melt the binding polymer and compact coated film, reducing porosity and increasing tap density and adhesion to the substrate. Hot calender rollers may have a width in the range of 1≤w≤48 inches, with a preferred range of 2≤w≤12 inches. It is understood that in instances where there are more than two hot rollers, the gap distance between the rollers decreases down the manufacturing line. The one or more hot calender rolling units may range in size from a benchtop unit, affixed to a lab bench affixed to the processing module, or a standalone industrial scale unit, affixed directly to the processing module floor

Processing equipment for wet-based processing may include one or more slitters, post hot calendering, that cut the substrate dimensions down to the desired width. The substrate may be directly rolled from the hot calender roller, or the last hot calender roller in the instance there are more than two hot rollers, to the slitter. The one or more slitting units may range in size from a benchtop unit, affixed to a lab bench affixed to the processing module, or a standalone industrial scale unit, affixed directly to the processing module floor.

Processing equipment for wet-based processing may include one or more additional drying ovens to perform a final dry before battery assembly. The final drying step may have a vacuum system to pull any residual solvent out from the compacted films. The one or more additional drying ovens may range in size from a benchtop unit, affixed to a lab bench affixed to the processing module, or a standalone industrial scale unit, affixed directly to the processing module floor

Additional processing equipment for wet-based processing may include, for example, one or more electrode shaping/notching equipment, one or more substrate winders, and one or more stacking and welding equipment (such as a Z-folding), one or more vacuum pouch sealers, one or more electrolyte filling stations, one or more jelly roll inserts, one or more button cell crimpers, etc. All additional processing equipment may range in size from a benchtop unit, affixed to a lab bench affixed to the processing module, or a standalone industrial scale unit, affixed directly to the manufacturing floor. Alternatively, one or more of the additional processing equipment is positioned outside the processing module. It is understood that once one step occurs outside the processing module, the remaining steps are likely, though not required, to be carried out outside the processing module.

Other battery processing equipment and wet-based processing steps not listed may be positioned inside the processing module or outside the processing module.

As detailed above, the second embodiment highlights the integration of wet-based processing processes within a modular dry room architecture, allowing for the controlled fabrication of moisture-sensitive battery components or full battery cells. The environmental regulation afforded by the control module enables solvent-based processing steps—such as slurry mixing, coating, drying, and densification—to be executed with minimal exposure to ambient humidity, while also supporting solvent recovery and recycling measures within or external to the processing module.

By housing key wet-process equipment within a hermetically sealed processing module and isolating environmental and utility management in a separate control module, the modular dry room system provides a clean, compact, and configurable platform that can be tailored to pilot-scale development or scaled production of next-generation batteries. This includes the ability to accommodate both component-level processing and full battery assembly workflows, depending on customer requirements.

The second embodiment further illustrates the flexibility and modularity of the system architecture, wherein wet-processing units may be configured as benchtop or floor-mounted equipment, adapted to lab-scale, pilot-scale, or production-scale formats. The ability to partition processes across modules or relocate individual steps outside the dry room allows for progressive scaling, process customization, and integration with existing manufacturing lines.

Overall, the second embodiment demonstrates how the modular dry room system may be used as a turnkey wet-processing solution to support the precise, environmentally regulated fabrication of battery materials and components critical to high-performance solid-state battery technologies.

The present description pertains to a solvent purification system within the processing module.

A processing module for wet-based processing may comprise a mechanism to neutralize or remove solvent vapor that escapes the oven drying system.

In an example, a solvent neutralization mechanism may include the primary air handling system, wherein the return ducts pull compromised air out of the processing module and into a solvent recycling system within the control module.

The solvent recycling system may take in the compromised return air and pass it along a cold block or chilling system which condenses the solvent vapor into a liquid and then expels the purified air out of the control module through the exhaust system. Alternatively, the purified air may be sent to a dehumidification process and returned to the processing module. A cold block or chilling system may be chilled using antifreeze, freon, dry ice, liquid nitrogen, ethylene glycol, etc.

The collected solvent may be recycled, or repurified and reused in the slurry-making process.

In another example, a solvent neutralization mechanism may include a secondary air handling system, wherein secondary return ducts pull compromised air out of the processing module and into a secondary solvent recycling system.

A secondary solvent recycling system may be located inside the processing module or outside the processing module.

The secondary solvent recycling system may take in the compromised return air and pass it along a cold block or chilling system which condenses the solvent vapor into a liquid and then expels the purified air out. A cold block or chilling system may be chilled using antifreeze, freon, dry ice, liquid nitrogen, ethylene glycol, etc.

The expelled purified air may be returned to the processing module through a secondary supply duct so as to not disrupt the primary air handling system.

In this example, it is understood that the primary and secondary air handling systems are programmed to work together in tandem.

Alternatively, the expelled purified air may not be returned to the processing module. In the case of the secondary recycling system being outside the processing module, the purified air is expelled directly from the system. In the case of the secondary recycling system being inside the processing module, the purified air may be exhausted through a secondary exhaust vent.

In this example, it is understood that the primary air handling systems are programmed to accommodate for the loss of air.

The collected solvent in the secondary recycling system may be recycled, or repurified and reused in the slurry-making process.

The solvent purification system described above provides a important environmental control mechanism for wet-based processing processes conducted within the processing module. By enabling recovery and neutralization of volatile organic compounds (VOCs) and moisture-laden air, the system contributes to workplace safety, regulatory compliance, and operational sustainability.

The integration of either a primary or secondary air handling system with the solvent recycling subsystem ensures that volatile solvent vapors generated during slurry drying or other solvent-based processing steps are actively captured and processed, preventing accumulation of hazardous gases and reducing the risk of flammability or exposure. This is especially relevant when handling solvents with low flash points or known health hazards.

Moreover, the described system architecture allows for strategic distribution of purification components across the control and processing modules. This modularization allows customers to tailor the configuration based on floor space constraints, solvent usage profiles, or retrofit needs. For instance, in smaller-scale implementations, a self-contained secondary recycling unit may be sufficient, whereas in higher-volume production settings, a dedicated chilled solvent recovery line routed to the control module may be more efficient.

The solvent recovery and repurification capability further enhances the environmental and economic profile of the modular dry room system. By enabling reuse of captured solvents, the system reduces waste, minimizes supply chain dependence on fresh solvent inventory, and lowers the cost per unit of battery material production.

Overall, the solvent purification system supports the broader goal of the modular dry room system as a self-contained, environmentally regulated, and production-ready platform for advanced battery processing, ensuring compliance with cleanroom standards while enabling efficient materials throughput and sustainability.

The present description pertains to a hydrogen sulfide purification system for a wet manufacturing process within the processing module.

Hydrogen sulfide gas (H₂S) gives off an unpleasant smell at concentrations well below >1 part per million or 0.0001% and can become dangerous at concentrations of ≥10 parts per million or 0.001%. Hydrogen sulfide gas is formed when sulfide-containing materials, such as sulfide-based solid-state ionic conductive materials or precursors for sulfide-based solid-state ionic conductive materials such as lithium sulfide, come into contact with moisture. However, being that the dry room may still contain moisture levels ≥10 parts per million or 0.001% worker safety may be compromised, especially with sulfide-based solid-state battery processing.

Therefore, a processing module for wet-based processing may comprise one or more purification systems to remove hydrogen sulfide gas from the air to ensure worker safety, especially during sulfide-based solid-state battery processing. However, most hydrogen sulfide purification systems in the art comprise an aqueous-based method that is not suitable for a dry room. Thus, a new purification method may be needed.

In an example, a hydrogen sulfide gas neutralization system may be described as an air purification unit comprising a high surface area copper mesh that reacts with hydrogen sulfide gas. The high surface area copper mesh is heated using resistive heating powered by the control module to accelerate the reaction with hydrogen sulfide gas. The air within the processing module is circulated through the copper mesh within the air purification unit.

The reaction between the hydrogen sulfide gas and copper mesh slowly converts the high surface area mesh into copper sulfide (CuS) with hydrogen gas as the by-product.

A copper mesh may be in the shape of a square, rectangle, tubular, etc.

A hydrogen sulfide gas neutralization system may comprise more than one copper mesh.

In another example, a hydrogen sulfide gas neutralization system may be described as an air purification unit comprising one or more porous compartments comprising a high surface area copper powder. The porous compartment may be heated to heat the copper powder accelerating the reaction with hydrogen sulfide gas. Heating may be controlled by the control module.

The reaction between the hydrogen sulfide gas and copper powder slowly converts the high surface area powder into copper sulfide (CuS) with hydrogen gas as the by-product.

It should be noted that the moisture concentration in the processing module is below 500 parts per million or 0.05%. Thus, the resulting hydrogen gas concentration is below 500 parts per million or 0.05%, well below the hazardous levels. Moreover, hydrogen gas is odorless which won't affect workers confront. A processing module may comprise a hydrogen gas sensor to monitor the area to further ensure worker safety. If the hydrogen gas reaches a threshold, an alarm may go off alerting workers to leave the module. The hydrogen gas may be removed from the processing module through the primary return duct.

A processing module may comprise a single copper-based hydrogen sulfide gas neutralization system or more than one copper-based hydrogen sulfide gas neutralization system.

The one or more copper-based hydrogen sulfide gas neutralization systems may be attached at the top of the manufacturing modular similar to a mini split or air purification system. Alternatively, the one or more copper-based hydrogen sulfide gas neutralization systems may sit upright and attached to the modular floor.

In yet another example, a hydrogen sulfide gas neutralization system may be described as an air purification unit comprising one or more porous compartments comprising a high surface area copper oxide powder. The porous compartment may be heated to heat the copper oxide powder to accelerate the reaction with hydrogen sulfide.

The reaction between the hydrogen sulfide gas and copper oxide powder slowly converts the high surface area powder into copper sulfide (CuS) with water as the by-product.

While water may be an unwanted byproduct in a hermetically sealed dry room module, it may be quickly removed from the processing module through the primary return duct.

A processing module may comprise one or more of the copper oxide-based gas neutralization system. Such systems are best placed near a primary return duct vent so as to remove the water as quickly as possible so that it does not have the chance to generate more hydrogen sulfide gas.

The copper-based hydrogen sulfide gas neutralization systems described above exemplify the adaptation of air purification technologies specifically suited for use in hermetically sealed, low-moisture environments such as modular dry room systems for battery processing. Unlike conventional aqueous-phase purification technologies, which would introduce unacceptable humidity levels, the described systems are fundamentally dry-phase in operation and thus maintain the integrity of the dry room environment. These systems offer a targeted approach for neutralizing hydrogen sulfide gas within an enclosed module while preserving the ultra-low dew point conditions necessary for processing sulfide-containing battery materials. Importantly, the integration of these gas neutralization systems with the control module—whether for heating regulation, sensor coordination, or air handling—is consistent with the broader system architecture wherein environmental control is physically and functionally separated from the manufacturing process. This separation allows for safe, stable, and predictable operation in chemically reactive environments, enabling scalable deployment of dry room systems tailored for next-generation battery chemistries.

The present description pertains to the third embodiment of the specification.

A modular dry room system is a turnkey solution for dry-based processing of next-generation batteries, particularly sulfide-based solid-state battery processing.

A processing module may comprise the necessary equipment for dry-based processing of next-generation battery components (i.e., cathodes and anodes). In the case of solid-state batteries, components may include a composite cathode, a composite anode, and a solid-state electrolyte membrane. The modular dry room system may be designed to manufacture only the components that are moisture sensitive (with battery assembly elsewhere) or manufacture the entire battery cell such as the case with a sulfide-based solid-state battery.

A dry-based processing process for freestanding components may have four stages: (Stage #1) Material homogenization, (Stage #2) 3D Fibrosis Mixing, (Stage #3) Omnidirectional film deposition, and (Stage #4) Hot calendar rolling.

The remaining battery processing steps may be done externally of the processing module, within the processing module, or in an alternative processing module. The remaining steps may include component lamination onto a current collector, slitting, electrode shaping/notching, component or battery layering, winding, stacking, welding, packaging, etc.

The present description pertains to Stage #1 of a dry manufacturing process within the processing module.

Stage #1 of the dry-based processing process encompasses a material homogenization stage that includes the uniform mixing of the material components.

Material components may include active electrode particles (cathode or anode), electronic additives, binding polymers, and solid-state ionic conductive ceramics.

Material homogenization may be accomplished using one or more benchtop mixers, V-mixers, vertical mills, horizontal mills, or roller mills.

The homogenized material mixture may be transferred to Stage #2 manually or through automation/robotics.

The present description pertains to Stage #2 of a dry manufacturing process within the manufacturing

Stage #2 of the dry-based processing process encompasses a 3D fibrous mixing stage.

A 3D fibrosis mixing stage is done to stretch out and elongate the binding polymers. An example of a binding polymer may include, for example, polytetrafluoroethylene.

Examples of other polymers may include, for example, polyethylene glycol, polyisobutene (e.g. OPPANOL™), polyvinylidene fluoride, polyvinyl alcohol. Additional examples of suitable polymer include, but are not limited to, polyolefins (e.g., polyethylenes, poly(butene-1), poly(n-pentene-2), polypropylene, polytetrafluoroethylene), polyamines (e.g., poly(ethylene imine) and polypropylene imine (PPI)); polyamides (e.g., polyamide (Nylon), poly(ϵ-caprolactam) (Nylon 6), poly(hexamethylene adipamide) (Nylon 66)), polyimides (e.g., polyimide, polynitrile, and poly(pyromellitimide-1,4-diphenyl ether) (Kapton®) (NOMEX®) (KEVLAR®)); polyether ether ketone (PEEK); vinyl polymers (e.g., polyacrylamide, poly(2-vinyl pyridine), poly(N-vinylpyrrolidone), poly(methylcyanoacrylate), poly(ethylcyanoacrylate), poly(butylcyanoacrylate), poly(isobutylcyanoacrylate), poly(vinyl acetate), poly(vinyl alcohol), poly(vinyl chloride), poly(vinyl fluoride), poly(2-vinyl pyridine), vinyl polymer, polychlorotrifluoro ethylene, and poly(isohexylcynaoacrylate)); polyacetals; polyesters (e.g., polycarbonate, polybutylene terephthalate, polyhydroxybutyrate); polyethers (poly(ethylene oxide) (PEO), poly(propylene oxide) (PPO), poly(tetramethylene oxide) (PTMO)); vinylidene polymers (e.g., polyisobutylene, poly(methyl styrene), poly(methylmethacrylate) (PMMA), poly(vinylidene chloride), and poly(vinylidene fluoride)); polyaramides (e.g., poly(imino-1,3-phenylene iminoisophthaloyl) and poly(imino-1,4-phenylene iminoterephthaloyl)); polyheteroaromatic compounds (e.g., polybenzimidazole (PBI), polybenzobisoxazole (PBO) and polybenzobisthiazole (PBT)); polyheterocyclic compounds (e.g., polypyrrole); polyurethanes; phenolic polymers (e.g., phenol-formaldehyde); polyalkynes (e.g., polyacetylene); polydienes (e.g., 1,2-polybutadiene, cis or trans-1,4-polybutadiene); polysiloxanes (e.g., poly(dimethylsiloxane) (PDMS), poly(diethylsiloxane) (PDES), polydiphenylsiloxane (PDPS), and polymethylphenylsiloxane (PMPS)); and inorganic polymers (e.g., polyphosphazene, polyphosphonate, polysilanes, polysilazanes). In some embodiments, the polymer may be selected from poly(n-pentene-2), polypropylene, polytetrafluoroethylene, polyamides (e.g., polyamide (Nylon), poly(ϵ-caprolactam) (Nylon 6), poly(hexamethylene adipamide) (Nylon 66)), polyimides (e.g., polynitrile, and poly(pyromellitimide-1,4-diphenyl ether) (Kapton®) (NOMEX®) (KEVLAR®)), polyether ether ketone (PEEK).

The 3D fibrosis mixing forms high surface area polymer filaments that can enhance the structural integrity of the battery component.

The present description pertains to Stage #3 of a dry manufacturing process within the processing module.

Stage #3 of the dry-based processing process encompasses omnidirectional film deposition to ensure the fibrous polymer filaments are omnidirectionally distributed.

Omnidirectional distribution may significantly improve the toughness or mechanical integrity of the battery component.

The present description pertains to Stage #4 of a dry manufacturing process within the processing module.

Stage #4 of the dry-based processing process encompasses hot calender rolling to soften the omnidirectional polymer filaments and densify the homogenized materials forming the freestanding components.

A dry-based processing process may include one set of hot calender rolling or more than one set of hot rollers in tandem.

A dry-based processing process may include a two-roller system for research and development stage of battery processing.

Alternatively, a dry-based processing process may include a four-roller system for a pre-pilot stage of battery processing.

In yet another alternative, a dry-based processing process may include a multi-hot roller system for pilot and mass production.

The dry-based processing process described herein provides an integrated, scalable, and environmentally controlled pathway for producing freestanding, moisture-sensitive battery components within a modular dry room system. Each of the four stages—material homogenization, 3D fibrosis mixing, omnidirectional film deposition, and hot calender rolling—is configured to occur entirely within the processing module, thereby minimizing exposure to atmospheric moisture while preserving material integrity throughout fabrication. The physical and functional separation of the control module and the processing module allows precise regulation of temperature, humidity, and air quality independent of manufacturing operations, supporting consistent production conditions even under variable external environments. This compartmentalized architecture not only facilitates quality control and modular deployment but also enables the system to be readily adapted for a variety of battery chemistries that require solvent-free processing or are otherwise incompatible with traditional wet-coating methods.

The present description pertains to a hydrogen sulfide purification system for a dry manufacturing process within the processing module.

Hydrogen sulfide gas (H₂S) gives off an unpleasant smell at concentrations well below >1 part per million or 0.0001% and can become dangerous at concentrations of ≥10 parts per million or 0.001%. Hydrogen sulfide gas is formed when sulfide-containing materials, such as sulfide-based solid-state ionic conductive materials or precursors for sulfide-based solid-state ionic conductive materials such as lithium sulfide, come into contact with moisture. However, being that the dry room may still contain moisture levels ≥10 parts per million or 0.001% worker safety may be compromised, especially with sulfide-based solid-state battery processing.

Therefore, a processing module for dry-based processing may comprise one or more purification systems to remove hydrogen sulfide gas from the air to ensure worker safety, especially during sulfide-based solid-state battery processing. However, most hydrogen sulfide purification systems in the art comprise an aqueous-based method that is not suitable for a dry room. Thus, a new purification method may be needed.

In an example, a hydrogen sulfide gas neutralization system may be described as an air purification unit comprising a high surface area copper mesh that reacts with hydrogen sulfide gas. The high surface area copper mesh is heated using resistive heating powered by the control module to accelerate the reaction with hydrogen sulfide gas. The air within the processing module is circulated through the copper mesh within the air purification unit.

The reaction between the hydrogen sulfide gas and copper mesh slowly converts the high surface area mesh into copper sulfide (CuS) with hydrogen gas as the by-product.

A copper mesh may be in the shape of a square, rectangle, tubular, etc.

A hydrogen sulfide gas neutralization system may comprise more than one copper mesh.

In another example, a hydrogen sulfide gas neutralization system may be described as an air purification unit comprising one or more porous compartments comprising a high surface area copper powder. The porous compartment may be heated to heat the copper powder accelerating the reaction with hydrogen sulfide gas. Heating may be controlled by the control module.

The reaction between the hydrogen sulfide gas and copper powder slowly converts the high surface area powder into copper sulfide (CuS) with hydrogen gas as the by-product.

It should be noted that the moisture concentration in the processing module is below 500 parts per million or 0.05%. Thus, the resulting hydrogen gas concentration is below 500 parts per million or 0.05%, well below the hazardous levels. Moreover, hydrogen gas is odorless which won't affect workers confront. A processing module may comprise a hydrogen gas sensor to monitor the area to further ensure worker safety. If the hydrogen gas reaches a threshold, an alarm may go off alerting workers to leave the module. The hydrogen gas may be removed from the processing module through the primary return duct.

A processing module may comprise a single copper-based hydrogen sulfide gas neutralization system or more than one copper-based hydrogen sulfide gas neutralization system.

The one or more copper-based hydrogen sulfide gas neutralization systems may be attached at the top of the manufacturing modular similar to a mini split or air purification system. Alternatively, the one or more copper-based hydrogen sulfide gas neutralization systems may sit upright and attached to the modular floor.

In yet another example, a hydrogen sulfide gas neutralization system may be described as an air purification unit comprising one or more porous compartments comprising a high surface area copper oxide powder. The porous compartment may be heated to heat the copper oxide powder to accelerate the reaction with hydrogen sulfide.

The reaction between the hydrogen sulfide gas and copper oxide powder slowly converts the high surface area powder into copper sulfide (CuS) with water as the by-product.

While water may be an unwanted byproduct in a hermetically sealed dry room module, it may be quickly removed from the processing module through the primary return duct.

A processing module may comprise one or more of the copper oxide-based gas neutralization system. Such systems are best placed near a primary return duct vent so as to remove the water as quickly as possible so that it does not have the chance to generate more hydrogen sulfide gas.

The integration of copper-based hydrogen sulfide gas neutralization systems into a dry processing module reinforces the capability of the modular dry room system to support sulfide-based solid-state battery production under strict environmental control. Unlike conventional aqueous-based purification methods that risk introducing additional moisture, the described dry-compatible neutralization systems maintain the low-dew-point conditions necessary for moisture-sensitive materials. These systems are designed for modular deployment and continuous operation, supporting both localized purification and integration with the primary air handling architecture. Moreover, because these purification units can be powered and regulated via the control module, system responsiveness can be adapted in real time based on sensor feedback, gas concentration thresholds, or process step requirements. This ensures not only the environmental integrity of the dry room but also the safety and comfort of personnel working within the processing module across varying operational scales.

The present description pertains to the fourth embodiment of the specification.

A next-generation battery may comprise an anode formed or laminated onto a negative current collector, a cathode formed or laminated onto a positive current collector, a separator used to physically separate the anode from the cathode, an electrolyte as an ion-conducting medium with the battery, and outer battery packaging.

A next-generation solid-state battery, particularly a sulfide-based solid-state battery may comprise a composite anode, comprising a solid-state ionic conducting material known in the art as an anolyte, formed or laminated onto a negative current collector, a composite cathode, comprising a solid-state ionic conducting material known in the art as a catholyte, formed or laminated onto a positive current collector, a solid-state ionic conducting membrane separating the composite anode and composite cathode, and out battery packaging.

A next-generation solid-state battery, particularly a sulfide-based solid-state battery may comprise an alkali metal anode formed or laminated onto a negative current collector, a composite cathode, comprising a solid-state ionic conducting material known in the art as a catholyte, formed or laminated onto a positive current collector, a solid-state ionic conducting membrane separating the alkali metal anode and composite cathode, and out battery packaging.

A next-generation solid-state battery, particularly a sulfide-based solid-state battery may comprise a negative current collector, a composite cathode, comprising a solid-state ionic conducting material known in the art as a catholyte, formed or laminated onto a positive current collector, a solid-state ionic conducting membrane separating the negative current collector and composite cathode, and out battery packaging in what is known in the art as an anodeless solid-state battery.

The present description pertains to an anode electrode in a next-generation battery.

An anode layer may be formed onto a negative current collector. A negative current collector may include, for example, copper foil.

An anode layer may include an alkali metal anode layer.

An alkali metal anode layer may include lithium metal which is commonly referred to in the art as a lithium metal battery.

Alternatively, a metal anode layer may include sodium, potassium, manganese, magnesium, zinc, iron, aluminum, etc.

In some instances, a next-generation battery may be devoid of an anode layer which is commonly referred to in the art as an anodeless or lithium-free battery.

An anode layer may include a composite anode layer.

A composite anode layer may comprise an active anode material, an inactive binder, an electronically conductivity additive, and an ionic conducting media known as the anolyte.

An active anode material may interact with ions through various mechanisms including, but not limited to, intercalation, alloying, plating, or conversion.

An active anode material may include, for example, lithium powder, titanium oxide, silicon, tin oxide, germanium, antimony, silicon oxide, iron oxide, cobalt oxide, ruthenium oxide, molybdenum oxide, molybdenum sulfide, chromium oxide, nickel oxide, manganese oxide, carbon-based materials (hard carbons, soft carbons, graphene, graphite's, carbon nanofibers, carbon nanotubes, etc.), or a combination thereof.

In the case of lithium powder, alloying materials may be introduced into the composite anode structure which may include, for example, tin, zinc, indium, magnesium, etc.

Active anode materials may be single crystal, polycrystalline, or amorphous.

Active anode material may be coated with a protected layer to enhance chemical stability with the anolyte.

Protective coatings may include, for example, carbon, lithium niobate (LiNbO₃), lithium borate (Li₂B₄O₇), lithium zirconate (Li₂ZrO₃), lithium titanate (Li₄Ti₅O₁₂), aluminum oxide (Al₂O₃), lithium metasilicate (Li₂SiO₃), etc.

A composite anode layer may include an inactive binder such as, for example, polyvinylidene fluoride, polyacrylic acid, lotader, carboxymethyl cellulose, styrene-butadiene rubber, sodium alginate, etc.

A composite anode layer may include an inactive electronically conductive additive such as, for example, graphene, reduced graphene oxide, carbon nanotubes, carbon black, Super P, acetylene black, vapor-grown carbon fibers, carbon nanofibers or a conductive polymer such as polyaniline, polypyrrole, poly(3,4-ethylenedioxythiophene (PEDOT), polyphenylene vinylene etc.

A composite anode layer may contain a small amount of inactive lithium additives such as lithium nitrate or lithium bis(oxalato)borate to serve as an excess lithium source.

A composite anode layer may include an anolyte formed from a solid-state ionic conductive material. A solid-state ionic conductive material can be described as a material that may have the following characteristics:

A solid-state ionic conductive material is a type of material that can selectively allow a specific charged element to pass through under the presence of an electric field or chemical potential, such as concentration differences.

While this solid-state ionic conductive material allows ions to migrate through, it may not allow electrons to pass easily.

The ions may carry 1, 2, 3, 4, or more positive charges. Examples of the charged ions include but are not limited to, H⁺, Li⁺, Na⁺, K⁺, Ag⁺, Mg²⁺, Zn²⁺, Fe³⁺, Al³⁺, etc.

The ionic conductivity of the corresponding ions is preferably to be >10⁻⁷ S/cm. It is preferable to have lower electrical conductivity (≤10⁻⁷ S/cm).

Examples of a solid-state ionic conductive material include but are not limited to a solid-state ionic conductive material includes Li₂ₓS_{x+w+5z}M_{y}P_{2z}, where x is 8-16, y is 0.1-6, w is 0.1-15, z is 0.1-3, and M is selected from the group consisting of lanthanides, Group 3, Group 4, Group 5, Group 6, Group 7, Group 8, Group 9, Group 12, Group 13, and Group 14 atoms, and combinations thereof.

In another example, a solid-state ionic conductive material includes argyrodites materials with the general formula: Li₁₂₋ₘ₋ₓ(MₘY₄²⁻)Y₂₋ₓ²⁻Xₓ⁻, wherein M^{m+}=B³⁺, Ga³⁺, Sb³⁺, Si⁴⁺, Ge⁴⁺, P⁵⁺, As⁵⁺, or a combination thereof; Y²⁻=O²⁻, S²⁻, Se²⁻, Te²⁻, or a combination thereof; X⁻=F⁻, Cl⁻, Br⁻, I⁻, or a combination thereof; and x is in the range of 0≤x≤2.

In yet another example, a solid-state ionic conductive material includes argyrodites materials with the general formula: Li₁₈₋₂ₘ₋ₓM^{2m}+Y₍₉₋ₓ₎₊ₙXₓ, wherein M^{m+}=B³⁺, Ga³⁺, Sb³⁺, Si⁴⁺, Ge⁴⁺, P⁵⁺, As⁵⁺, or a combination thereof; Y²⁻=O²⁻, S²⁻, Se²⁻, Te²⁻, or a combination thereof; X⁻=F⁻, Cl⁻, Br⁻, I⁻, or a combination thereof; and x is in the range of 0≤x≤2.

In yet another example, a solid-state ionic conductive material include a garnet-like structure oxide material with the general formula:

$${Li}_{n} [ {A}_{( 3 - {a}^{′} - {a}^{″} )} {A}_{( {a}^{′} )}^{′} {A}_{( {a}^{″} )}^{″} ] [ {B}_{( 2 - {b}^{′} - {b}^{″} )} {B}_{( {b}^{′} )}^{′} {B}_{( {b}^{″} )}^{″} ] [ {C}_{( {c}^{′} )}^{′} {C}_{( {c}^{″} )}^{″} ] {O}_{12} ,$$

a. where A, A′, and A″ stand for a dodecahedral position of the crystal structure, i. where A stands for one or more trivalent rare earth elements, ii. where A′ stands for one or more alkaline earth elements, iii. where A″ stands for one or more alkaline metal elements other than Li, and iv, wherein 0≤a′≤2 and 0≤a″≤1;
b. where B, B′, and B″ stand for an octahedral position of the crystal structure, i. where B stands for one or more tetravalent elements, ii. where B′ stands for one or more pentavalent elements, iii. where B″ stands for one or more hexavalent elements, and iv, wherein 0≤b′, 0≤b″, and b′+b″≤2;
c. where C′ and C″ stand for a tetrahedral position of the crystal structure, i. where C′ stands for one or more of Al, Ga, and boron, ii. where C″ stands for one or more of Si and Ge, and iii, wherein 0≤c′≤0.5 and 0≤c″≤0.4; and
d, wherein n=7+a′+2·a″−b′−2·b″−3·c′−4·c″ and 4.5≤n≤7.5.

In yet another example, a solid-state ionic conductive material includes perovskite-type oxides such as (Li,La)TiO₃ or doped or replaced compounds.

In yet another example, a solid-state ionic conductive material includes NASICON-structured lithium membrane, such as LAGP (Li₁₋ₓAlₓGe₂₋ₓ(PO₄)₃), LATP (Li₁₊ₓAlₓTi₂₋ₓ(PO₄)₃) and these materials with other elements doped therein.

In yet another example, a solid-state ionic conductive material includes anti-perovskite structure materials and their derivatives, such as the composition of Li₃OCl, Li₃OBr, and Li₃OI.

In yet another example, a solid-state ionic conductive material includes the Li₃YH₆(H=F, Cl, Br, I) family of materials, Y can be replaced by other trivalent elements.

In yet another example, a solid-state ionic conductive material includes alkali metal halides with the general formula AₐM_{b}^{m+}M′_{b′}^{m′+}X_{a+mb+m′b′}, where A=Li⁺, Na⁺, K⁺, or a combination thereof, X⁻=F⁻, Cl⁻, Br⁻, I⁻, or a combination thereof, M^{m+}=Ti²⁺, V²⁺, Cr²⁺, Mn²⁺, Fe²⁺, Co²⁺, Ni²⁺, Cu²⁺, Zn²⁺, Cd²⁺, Mg²⁺, Pb²⁺, Y³⁺, Sc³⁺, Lu³⁺, La³⁺, Al³⁺, Ga³⁺, In³⁺, Er³⁺, Ho³⁺, Ti³⁺, Cr³⁺, V³⁺, Hf⁴⁺, Zr⁴⁺, V⁴⁺, Ti⁴⁺, Mo⁴⁺, W⁴⁺, V⁵⁺, Nb⁵⁺, Ta⁵⁺, Cr³⁺, Mo⁶⁺, W⁶⁺, etc., and M^{′m+} may be metal with the same valance state as M^{m+} when b′ is greater than 0, or an aliovalent substitution when b′ is greater than 0.

An anolyte may include a mixture of two or more solid-state ionic conductive materials.

The present description pertains to a cathode electrode in a next-generation battery.

A cathode layer may be formed onto a positive current collector. A positive current collector may include, for example, aluminum foil.

A cathode layer may comprise a cathode active material, an inactive binder, and an electronic conductivity additive. In the case of a solid-state battery, a composite cathode layer may further comprise a solid-state ionic conducting material known as the catholyte.

A cathode active materials may include intercalation material such as, for example, layered YMO₂, Y-rich layered Y^{1+x}M^{1-x}O₂, spinel YM₂O₄, olivine YMPO₄, silicate Y₂MSiO₄, borate YMBO₃, tavorite YMPO₄F (where M is Fe, Co, Ni, Mn, Cu, Cr, etc.), (where Y is Li, Na, K, Mg, Zn, Al, etc.), vanadium oxides, sulfur, lithium sulfide, iron sulfide, FeF₃, LiSe.

In the case of a lithium intercalation, active cathode materials may include, for example, lithium iron phosphate (LiFePO₄), lithium cobalt oxide (LiCoO₂), lithium manganese oxide (LiMn₂O₄), and lithium nickel oxide (LiNiO₂), lithium nickel cobalt manganese oxide (LiNiₓCo_{y}Mn_{z}O₂, 0.95≥x≥0.5, 0.3≥y≥0.025, 0.2≥z≥0.025), lithium nickel cobalt aluminum oxide (LiNiₓCo_{y}Al_{z}O₂, 0.95≥x≥0.5, 0.3≥y≥0.025, 0.2≥z≥0.025), lithium nickel manganese spinel (LiNi_{0.5}Mn_{1.5}O₄), etc.

Active cathode materials may be single crystal, polycrystalline, or amorphous.

Active cathode material may be coated with a protected layer to enhance chemical stability with a catholyte.

Protective coatings may include, for example, carbon, lithium niobate (LiNbO₃), lithium borate (Li₂B₄O₇), lithium zirconate (Li₂ZrO₃), lithium titanate (Li₄Ti₅O₁₂), aluminum oxide (Al₂O₃), lithium metasilicate (Li₂SiO₃), etc.

A cathode layer may include an inactive binder such as, for example, polyvinylidene fluoride, polyacrylic acid, lotader, carboxymethyl cellulose, styrene-butadiene rubber, sodium alginate, etc.

A cathode layer may include an inactive electronically conductive additive such as, for example, graphene, reduced graphene oxide, carbon nanotubes, carbon black, Super P, acetylene black, vapor-grown carbon fibers, carbon nanofibers or a conductive polymer such as polyaniline, polypyrrole, poly(3,4-ethylenedioxythiophene (PEDOT), polyphenylene vinylene etc.

A cathode layer may contain a small amount of inactive lithium additives such as lithium nitrate or lithium bis(oxalato)borate to serve as of excess lithium source.

A composite cathode layer may include a catholyte formed from a solid-state ionic conductive material. A solid-state ionic conductive material can be described as a material that may have the following characteristics:

A solid-state ionic conductive material is a type of material that can selectively allow a specific charged element to pass through under the presence of an electric field or chemical potential, such as concentration differences.

While this solid-state ionic conductive material allows ions to migrate through, it may not allow electrons to pass easily.

The ions may carry 1, 2, 3, 4, or more positive charges. Examples of the charged ions include but are not limited to H⁺, Li⁺, Na⁺, K⁺, Ag⁺, Mg²⁺, Zn²⁺, Fe³⁺, Al³⁺, etc.

The ionic conductivity of the corresponding ions is preferably to be >10⁻⁷ S/cm. It is preferable to have lower electrical conductivity (≤10⁻⁷ S/cm).

Examples of a solid-state ionic conductive material include but are not limited to a solid-state ionic conductive material includes Li₂ₓS_{x+w+5z}M_{y}P_{2z}, where x is 8-16, y is 0.1-6, w is 0.1-15, z is 0.1-3, and M is selected from the group consisting of lanthanides, Group 3, Group 4, Group 5, Group 6, Group 7, Group 8, Group 9, Group 12, Group 13, and Group 14 atoms, and combinations thereof.

In another example, a solid-state ionic conductive material includes argyrodites materials with the general formula: Li₁₂₋ₘ₋ₓ(MₘY₄²⁻)Y₂₋ₓ²⁻Xₓ⁻, wherein M^{m+}=B³⁺, Ga³⁺, Sb³⁺, Si⁴⁺, Ge⁴⁺, P⁵⁺, As⁵⁺, or a combination thereof; Y²⁻=O²⁻, S²⁻, Se²⁻, Te²⁻, or a combination thereof; X⁻=F⁻, Cl⁻, Br⁻, I⁻, or a combination thereof; and x is in the range of 0≤x≤2.

In yet another example, a solid-state ionic conductive material includes argyrodites materials with the general formula: Li₁₈₋₂ₘ₋ₓM₂^{m+}Y₍₉₋ₓ₎₊ₙXₓ, wherein M^{m+}=B³⁺, Ga³⁺, Sb³⁺, Si⁴⁺, Ge⁴⁺, P⁵⁺, As⁵⁺, or a combination thereof; Y²⁻=O²⁻, S²⁻, Se²⁻, Te²⁻, or a combination thereof; X⁻=F⁻, Cl⁻, Br⁻, I⁻, or a combination thereof; and x is in the range of 0≤x≤2.

In yet another example, a solid-state ionic conductive material include a garnet-like structure oxide material with the general formula:

$${Li}_{n} [ {A}_{( 3 - {a}^{′} - {a}^{″} )} {A}_{( {a}^{′} )}^{′} {A}_{( {a}^{″} )}^{″} ] [ {B}_{( 2 - {b}^{′} - {b}^{″} )} {B}_{( {b}^{′} )}^{′} {B}_{( {b}^{″} )}^{″} ] [ {C}_{( {c}^{′} )}^{′} {C}_{( {c}^{″} )}^{″} ] {O}_{12} ,$$

a. where A, A′, and A″ stand for a dodecahedral position of the crystal structure, i. where A stands for one or more trivalent rare earth elements, ii. where A′ stands for one or more alkaline earth elements, iii. where A″ stands for one or more alkaline metal elements other than Li, and iv, wherein 0≤a′≤2 and 0≤a″≤1;
b. where B, B′, and B″ stand for an octahedral position of the crystal structure, i. where B stands for one or more tetravalent elements, ii. where B′ stands for one or more pentavalent elements, iii. where B″ stands for one or more hexavalent elements, and iv, wherein 0≤b′, 0≤b″, and b′+b″≤2;
c. where C′ and C″ stand for a tetrahedral position of the crystal structure, i. where C′ stands for one or more of Al, Ga, and boron, ii. where C″ stands for one or more of Si and Ge, and iii, wherein 0≤c′≤0.5 and 0≤c″≤0.4; and
d, wherein n=7+a′+2·a″−b′−2·b″−3·c′−4·c″ and 4.5≤n≤7.5.

In yet another example, a solid-state ionic conductive material includes perovskite-type oxides such as (Li,La)TiO₃ or doped or replaced compounds.

In yet another example, a solid-state ionic conductive material includes NASICON-structured lithium membrane, such as LAGP (Li₁₋ₓAlₓGe₂₋ₓ(PO₄)₃), LATP (Li₁₊ₓAlₓTi₂₋ₓ(PO₄)₃) and these materials with other elements doped therein.

In yet another example, a solid-state ionic conductive material includes anti-perovskite structure materials and their derivatives, such as the composition of Li₃OCl, Li₃OBr, and Li₃OI.

In yet another example, a solid-state ionic conductive material includes the Li₃YH₆ (H=F, Cl, Br, I) family of materials, Y can be replaced by other trivalent elements.

In yet another example, a solid-state ionic conductive material includes alkali metal halides with the general formula AₐM_{b}^{m+}M′_{b′}^{m′+}X_{a+mb+m′b′}, where A=Li⁺, Na⁺, K⁺, or a combination thereof, X⁻=F⁻, Cl⁻, Br⁻, I⁻, or a combination thereof, M^{m+}=Ti²⁺, V²⁺, Cr²⁺, Mn²⁺, Fe²⁺, Co²⁺, Ni²⁺, Cu²⁺, Zn²⁺, Cd²⁺, Mg²⁺, Pb²⁺, Y³⁺, Sc³⁺, Lu³⁺, La³⁺, Al³⁺, Ga³⁺, In³⁺, Er³⁺, Ho³⁺, Ti³⁺, Cr³⁺, V³⁺, Hf⁴⁺, Zr⁴⁺, V⁴⁺, Ti⁴⁺, Mo⁴⁺, W⁴⁺, V⁵⁺, Nb⁵⁺, Ta⁵⁺, Cr⁶⁺, Mo⁶⁺, W⁶⁺, etc., and M′^{m+} may be metal with the same valance state as M^{m+} when b′ is greater than 0, or an aliovalent substitution when b′ is greater than 0.

A catholyte may include a mixture of two or more solid-state ionic conductive materials.

The present description pertains to an electrolyte in a next-generation battery.

An electrolyte for a next-generation battery may include an organic-based liquid electrolyte, a polymer-based electrolyte, a gel polymer-based electrolyte, or a solid-state electrolyte layer.

An organic-based liquid electrolyte may comprise a solvent and an ionic conducting salt.

Examples of solvent for an a organic-based liquid electrolyte may include, but not limited to, ethylene carbonate (EC), fluoroethylene carbonate (FEC), propylene carbonate (PC), ethyl-methyl carbonate (EMC), dimethyl carbonate (DMC), diethyl carbonate (DEC), dimethyl ether (DME), diethylene glycol dimethyl ether (DEGDME), tetraethylene glycol dimethyl ether (TEGDME), 1,3-dioxolane (DOL), and 1-ethyl-3-methylimidoxzoium chloride and the mixtures of two or more of them.

[Examples of an ionic conducting salt for an a organic-based liquid electrolyte may include, but not limited to, lithium bis(trifluoromethanesulfonyl)imide (LiTFSI) and lithium bis(fluorosulfonyl)imide (LiFSI), lithium bis(oxalato)borate (LiBOB), lithium Difluro(oxalato)borate (LiDFOB), LiSCN, LiBr, LiI, LiClO₄, LiAsF₆, LiSO₃CF₃, LiSO₃CH₃, LiBF₄, LiB(Ph)₄, LiPF₆, LiC(SO₂CF₃)₃, LiN(SO₂CF₃)₂), LiNO₃, sodium bis(trifluoromethanesulfonyl)imide (NaTFSI) and sodium bis(fluorosulfonyl)imide (NaFSI), sodium bis(oxalato)borate (NaBOB) Sodium-difluoro(oxalato)borate (NaDFOB), NaSCN, NaBr, NaI, NaAsF₆, NaSO₃CF₃, NaSO₃CH₃, NaBF₄, NaPF₆, NaN(SO₂F)₂, NaClO₄, NaN(SO₂CF₃)₂, NaNO₃, magnesium bis(trifluoromethanesulfonyl)imide (Mg(TFSI)₂) and magnesium bis(fluorosulfonyl)imide (Mg(FSI)₂), magnesium bis(oxalato)borate (Mg(BOB)₂), magnesium Difluro(oxalato)borate (Mg(DFOB)₂), Mg(SCN)₂, MgBr₂, MgI₂, Mg(ClO₄)₂, Mg(AsF₆)₂, Mg(SO₃CF₃)₂, Mg(SO₃CH₃)₂, Mg(BF₄)₂, Mg(PF₆)₂, Mg(NO₃)₂, Mg(CH₃COOH)₂, potassium bis(trifluoromethanesulfonyl)imide (KTFSI) and potassium bis(fluorosulfonyl)imide (KFSI), potassium bis(oxalato)borate (KBOB), potassium Difluro(oxalato)borate (KDFOB), KSCN, KBr, KI, KClO₄, KASF₆, KSO₃CF₃, KSO₃CH₃, KBF₄, KB(Ph)₄, KPF₆, KC(SO₂CF₃)₃, KN(SO₂CF₃)₂), KNO₃, Al(NO₃)₂, AlCl₃, Al₂(SO₄)₃, AlBr₃, AlI₃, AlN, AlSCN, Al(ClO₄)₃.

A polymer-based electrolyte layer may comprise a crosslinked polymer matrix, an ionic conducting salt, and nonionic conductive additives.

Polymers for the crosslinked polymer matrix may be ionic conducting polymers or nonionic conducting polymers.

Examples of polymers included, but not limited to, polyethylene glycol, polyisobutene (e.g. OPPANOL™), polyvinylidene fluoride, polyvinyl alcohol. Additional examples of suitable polymer include, but are not limited to, polyolefins (e.g., polyethylenes, poly(butene-1), poly(n-pentene-2), polypropylene, polytetrafluoroethylene), polyamines (e.g., poly(ethylene imine) and polypropylene imine (PPI)); polyamides (e.g., polyamide (Nylon), poly(ϵ-caprolactam) (Nylon 6), poly(hexamethylene adipamide) (Nylon 66)), polyimides (e.g., polyimide, polynitrile, and poly(pyromellitimide-1,4-diphenyl ether) (Kapton®) (NOMEX®) (KEVLAR®)); polyether ether ketone (PEEK); vinyl polymers (e.g., polyacrylamide, poly(2-vinyl pyridine), poly(N-vinylpyrrolidone), poly(methylcyanoacrylate), poly(ethylcyanoacrylate), poly(butylcyanoacrylate), poly(isobutylcyanoacrylate), poly(vinyl acetate), poly(vinyl alcohol), poly(vinyl chloride), poly(vinyl fluoride), poly(2-vinyl pyridine), vinyl polymer, polychlorotrifluoro ethylene, and poly(isohexylcynaoacrylate)); polyacetals; polyesters (e.g., polycarbonate, polybutylene terephthalate, polyhydroxybutyrate); polyethers (poly(ethylene oxide) (PEO), poly(propylene oxide) (PPO), poly(tetramethylene oxide) (PTMO)); vinylidene polymers (e.g., polyisobutylene, poly(methyl styrene), poly(methylmethacrylate) (PMMA), poly(vinylidene chloride), and poly(vinylidene fluoride)); polyaramides (e.g., poly(imino-1,3-phenylene iminoisophthaloyl) and poly(imino-1,4-phenylene iminoterephthaloyl)); polyheteroaromatic compounds (e.g., polybenzimidazole (PBI), polybenzobisoxazole (PBO) and polybenzobisthiazole (PBT)); polyheterocyclic compounds (e.g., polypyrrole); polyurethanes; phenolic polymers (e.g., phenol-formaldehyde); polyalkynes (e.g., polyacetylene); polydienes (e.g., 1,2-polybutadiene, cis or trans-1,4-polybutadiene); polysiloxanes (e.g., poly(dimethylsiloxane) (PDMS), poly(diethylsiloxane) (PDES), polydiphenylsiloxane (PDPS), and polymethylphenylsiloxane (PMPS)); and inorganic polymers (e.g., polyphosphazene, polyphosphonate, polysilanes, polysilazanes). In some embodiments, the polymer may be selected from poly(n-pentene-2), polypropylene, polytetrafluoroethylene, polyamides (e.g., polyamide (Nylon), poly(ϵ-caprolactam) (Nylon 6), poly(hexamethylene adipamide) (Nylon 66)), polyimides (e.g., polynitrile, and poly(pyromellitimide-1,4-diphenyl ether) (Kapton®) (NOMEX®) (KEVLAR®)), polyether ether ketone (PEEK).

Polymer-based secondary battery electrolytes may include and ionic conducting salt. Examples of ionic conducting salts may include, but not limited to, lithium bis(trifluoromethanesulfonyl)imide (LiTFSI) and lithium bis(fluorosulfonyl)imide (LiFSI), lithium bis(oxalato)borate (LiBOB), lithium Difluro(oxalato)borate (LiDFOB), LiSCN, LiBr, LiI, LiClO₄, LiAsF₆, LiSO₃CF₃, LiSO₃CH₃, LiBF₄, LiB(Ph)₄, LiPF₆, LiC(SO₂CF₃)₃, LiN(SO₂CF₃)₂), LiNO₃, sodium bis(trifluoromethanesulfonyl)imide (NaTFSI) and sodium bis(fluorosulfonyl)imide (NaFSI), sodium bis(oxalato)borate (NaBOB) Sodium-difluoro(oxalato)borate (NaDFOB), NaSCN, NaBr, NaI, NaAsF₆, NaSO₃CF₃, NaSO₃CH₃, NaBF₄, NaPF₆, NaN(SO₂F)₂, NaClO₄, NaN(SO₂CF₃)₂, NaNO₃, magnesium bis(trifluoromethanesulfonyl)imide (Mg(TFSI)₂) and magnesium bis(fluorosulfonyl)imide (Mg(FSI)₂), magnesium bis(oxalato)borate (Mg(BOB)₂), magnesium Difluro(oxalato)borate (Mg(DFOB)₂), Mg(SCN)₂, MgBr₂, MgI₂, Mg(ClO₄)₂, Mg(AsF₆)₂, Mg(SO₃CF₃)₂, Mg(SO₃CH₃)₂, Mg(BF₄)₂, Mg(PF₆)₂, Mg(NO₃)₂, Mg(CH₃COOH)₂, potassium bis(trifluoromethanesulfonyl)imide (KTFSI) and potassium bis(fluorosulfonyl)imide (KFSI), potassium bis(oxalato)borate (KBOB), potassium Difluro(oxalato)borate (KDFOB), KSCN, KBr, KI, KClO₄, KASF₆, KSO₃CF₃, KSO₃CH₃, KBF₄, KB(Ph)₄, KPF₆, KC(SO₂CF₃)₃, KN(SO₂CF₃)₂), KNO₃, Al(NO₃)₂, AlCl₃, Al₂(SO₄)₃, AlBr₃, AlI₃, AlN, AlSCN, Al(ClO₄)₃.

In some instances, nonionic conducting additives may be used in the polymer matrix. Nonionic conductive additives may include, but not limited to, inorganics such as alumina, titania, lanthanum oxide or zirconia; epoxies, resins, plasticizers, surfactants, binders etc.

A gel polymer electrolyte may be defined as, but not limited, a polymer matrix, an ionic conducting salt and a liquid-based electrolyte.

Polymers for the crosslinked polymer matrix in a gel polymer electrolyte may be ionic conducting polymers or nonionic conducting polymers.

Examples of polymers include, but not limited to, polyethylene glycol, polyisobutene (e.g. OPPANOL™), polyvinylidene fluoride, polyvinyl alcohol. Additional examples of suitable polymer include, but are not limited to, polyolefins (e.g., polyethylenes, poly(butene-1), poly(n-pentene-2), polypropylene, polytetrafluoroethylene), polyamines (e.g., poly(ethylene imine) and polypropylene imine (PPI)); polyamides (e.g., polyamide (Nylon), poly(ϵ-caprolactam) (Nylon 6), poly(hexamethylene adipamide) (Nylon 66)), polyimides (e.g., polyimide, polynitrile, and poly(pyromellitimide-1,4-diphenyl ether) (Kapton®) (NOMEX®) (KEVLAR®)); polyether ether ketone (PEEK); vinyl polymers (e.g., polyacrylamide, poly(2-vinyl pyridine), poly(N-vinylpyrrolidone), poly(methylcyanoacrylate), poly(ethylcyanoacrylate), poly(butylcyanoacrylate), poly(isobutylcyanoacrylate), poly(vinyl acetate), poly(vinyl alcohol), poly(vinyl chloride), poly(vinyl fluoride), poly(2-vinyl pyridine), vinyl polymer, polychlorotrifluoro ethylene, and poly(isohexylcynaoacrylate)); polyacetals; polyesters (e.g., polycarbonate, polybutylene terephthalate, polyhydroxybutyrate); polyethers (poly(ethylene oxide) (PEO), poly(propylene oxide) (PPO), poly(tetramethylene oxide) (PTMO)); vinylidene polymers (e.g., polyisobutylene, poly(methyl styrene), poly(methylmethacrylate) (PMMA), poly(vinylidene chloride), and poly(vinylidene fluoride)); polyaramides (e.g., poly(imino-1,3-phenylene iminoisophthaloyl) and poly(imino-1,4-phenylene iminoterephthaloyl)); polyheteroaromatic compounds (e.g., polybenzimidazole (PBI), polybenzobisoxazole (PBO) and polybenzobisthiazole (PBT)); polyheterocyclic compounds (e.g., polypyrrole); polyurethanes; phenolic polymers (e.g., phenol-formaldehyde); polyalkynes (e.g., polyacetylene); polydienes (e.g., 1,2-polybutadiene, cis or trans-1,4-polybutadiene); polysiloxanes (e.g., poly(dimethylsiloxane) (PDMS), poly(diethylsiloxane) (PDES), polydiphenylsiloxane (PDPS), and polymethylphenylsiloxane (PMPS)); and inorganic polymers (e.g., polyphosphazene, polyphosphonate, polysilanes, polysilazanes). In some embodiments, the polymer may be selected from poly(n-pentene-2), polypropylene, polytetrafluoroethylene, polyamides (e.g., polyamide (Nylon), poly(ϵ-caprolactam) (Nylon 6), poly(hexamethylene adipamide) (Nylon 66)), polyimides (e.g., polynitrile, and poly(pyromellitimide-1,4-diphenyl ether) (Kapton®) (NOMEX®) (KEVLAR®)), polyether ether ketone (PEEK).

Examples of ionic conducting salts may include, but not limited to, lithium bis(trifluoromethanesulfonyl)imide (LiTFSI) and lithium bis(fluorosulfonyl)imide (LiFSI), lithium bis(oxalato)borate (LiBOB), lithium Difluro(oxalato)borate (LiDFOB), LiSCN, LiBr, LiI, LiClO₄, LiAsF₆, LiSO₃CF₃, LiSO₃CH₃, LiBF₄, LiB(Ph)₄, LiPF₆, LiC(SO₂CF₃)₃, LiN(SO₂CF₃)₂), LiNO₃, sodium bis(trifluoromethanesulfonyl)imide (NaTFSI) and sodium bis(fluorosulfonyl)imide (NaFSI), sodium bis(oxalato)borate (NaBOB) Sodium-difluoro(oxalato)borate (NaDFOB), NaSCN, NaBr, NaI, NaAsF₆, NaSO₃CF₃, NaSO₃CH₃, NaBF₄, NaPF₆, NaN(SO₂F)₂, NaClO₄, NaN(SO₂CF₃)₂, NaNO₃, magnesium bis(trifluoromethanesulfonyl)imide (Mg(TFSI)₂) and magnesium bis(fluorosulfonyl)imide (Mg(FSI)₂), magnesium bis(oxalato)borate (Mg(BOB)₂), magnesium Difluro(oxalato)borate (Mg(DFOB)₂), Mg(SCN)₂, MgBr₂, MgI₂, Mg(ClO₄)₂, Mg(AsF₆)₂, Mg(SO₃CF₃)₂, Mg(SO₃CH₃)₂, Mg(BF₄)₂, Mg(PF₆)₂, Mg(NO₃)₂, Mg(CH₃COOH)₂, potassium bis(trifluoromethanesulfonyl)imide (KTFSI) and potassium bis(fluorosulfonyl)imide (KFSI), potassium bis(oxalato)borate (KBOB), potassium Difluro(oxalato)borate (KDFOB), KSCN, KBr, KI, KClO₄, KASF₆, KSO₃CF₃, KSO₃CH₃, KBF₄, KB(Ph)₄, KPF₆, KC(SO₂CF₃)₃, KN(SO₂CF₃)₂), KNO₃, Al(NO₃)₂, AlCl₃, Al₂ (SO₄)₃, AlBr₃, AlI₃, AlN, AlSCN, Al(ClO₄)₃.

In some instances, nonionic conducting additives may be used in the polymer matrix.

Nonionic conductive additives may include, but not limited to, inorganics such as alumina, titania, lanthanum oxide or zirconia; epoxies, resins, plasticizers, surfactants, binders etc.

Liquid based electrolytes in gel polymer electrolytes may include, but not limited to organic based liquid electrolyte and ionic liquid electrolyte.

A gel polymer electrolyte may include an organic based liquid electrolyte. Examples of organic based liquid electrolyte may include, but not limited to, ethylene carbonate (EC), fluoroethylene carbonate (FEC), propylene carbonate (PC), ethyl-methyl carbonate (EMC), dimethyl carbonate (DMC), diethyl carbonate (DEC), dimethyl ether (DME), diethylene glycol dimethyl ether (DEGDME), tetraethylene glycol dimethyl ether (TEGDME), 1,3-dioxolane (DOL), and 1-ethyl-3-methylimidoxzoium chloride and the mixtures of two or more of them.

A gel polymer electrolyte may include a room temperature ionic liquid electrolyte. Examples of room temperature ionic liquid electrolytes may include, but not limited to, imidazolium, pyrrolidinium, piperidinium, ammonium, hexafluorophosphate, dicyanamide, tetrachloroaluminate, sulfonium, phosphonium, pyridinium, pyrazolium and thiazolium.

A gel polymer electrolyte may consist of a mixture of organic-based liquid electrolyte and room temperature ionic liquid electrolyte.

A solid-state electrolyte layer may include a solid-state ionic conductive material. A solid-state ionic conductive material can be described as a material that may have the following characteristics:

A solid-state ionic conductive material is a type of material that can selectively allow a specific charged element to pass through under the presence of an electric field or chemical potential, such as concentration differences.

While this solid-state ionic conductive material allows ions to migrate through, it may not allow electrons to pass easily.

The ions may carry 1, 2, 3, 4, or more positive charges. Examples of the charged ions include but are not limited to H⁺, Li⁺, Na⁺, K⁺, Ag⁺, Mg²⁺, Zn²⁺, Fe³⁺, Al³⁺, etc.

The ionic conductivity of the corresponding ions is preferably to be >10⁻⁷ S/cm. It is preferable to have lower electrical conductivity (≤10⁻⁷ S/cm).

Examples of a solid-state ionic conductive material include but are not limited to a solid-state ionic conductive material includes Li₂ₓS_{x+w+5z}M_{y}P_{2z}, where x is 8-16, y is 0.1-6, w is 0.1-15, z is 0.1-3, and M is selected from the group consisting of lanthanides, Group 3, Group 4, Group 5, Group 6, Group 7, Group 8, Group 9, Group 12, Group 13, and Group 14 atoms, and combinations thereof.

In another example, a solid-state ionic conductive material includes argyrodites materials with the general formula: Li₁₂₋ₘ₋ₓ(MₘY₄²⁻)Y₂₋ₓ²⁻Xₓ⁻, wherein M^{m+}=B³⁺, Ga³⁺, Sb³⁺, Si⁴⁺, Ge⁴⁺, P⁵⁺, As⁵⁺, or a combination thereof; Y²⁻=O²⁻, S²⁻, Se²⁻, Te²⁻, or a combination thereof; X⁻=F⁻, Cl⁻, Br⁻, I⁻, or a combination thereof; and x is in the range of 0≤x≤2.

In yet another example, a solid-state ionic conductive material includes argyrodites materials with the general formula: Li₁₈₋₂ₘ₋ₓM^{2m+}Y₍₉₋ₓ₎₊ₙXₓ, wherein M^{m+}=B³⁺, Ga³⁺, Sb³⁺, Si⁴⁺, Ge⁴⁺, P⁵⁺, As⁵⁺, or a combination thereof; Y²⁻=O²⁻, S²⁻, Se²⁻, Te²⁻, or a combination thereof; X⁻=F⁻, Cl⁻, Br⁻, I⁻, or a combination thereof; and x is in the range of 0≤x≤2.

In yet another example, a solid-state ionic conductive material include a garnet-like structure oxide material with the general formula:

$${Li}_{n} [ {A}_{( 3 - {a}^{′} - {a}^{″} )} {A}_{( {a}^{′} )}^{′} {A}_{( {a}^{″} )}^{″} ] [ {B}_{( 2 - {b}^{′} - {b}^{″} )} {B}_{( {b}^{′} )}^{′} {B}_{( {b}^{″} )}^{″} ] [ {C}_{( {c}^{′} )}^{′} {C}_{( {c}^{″} )}^{″} ] {O}_{12} ,$$

a. where A, A′, and A″ stand for a dodecahedral position of the crystal structure, i. where A stands for one or more trivalent rare earth elements, ii. where A′ stands for one or more alkaline earth elements, iii. where A″ stands for one or more alkaline metal elements other than Li, and iv, wherein 0≤a′≤2 and 0≤a″≤1;
b. where B, B′, and B″ stand for an octahedral position of the crystal structure, i. where B stands for one or more tetravalent elements, ii. where B′ stands for one or more pentavalent elements, iii. where B″ stands for one or more hexavalent elements, and iv, wherein 0≤b′, 0≤b″, and b′+b″≤2;
c. where C′ and C″ stand for a tetrahedral position of the crystal structure, i. where C′ stands for one or more of Al, Ga, and boron, ii. where C″ stands for one or more of Si and Ge, and iii, wherein 0≤c′≤0.5 and 0≤c″≤0.4; and
d, wherein n=7+a′+2·a″−b′−2·b″−3·c′−4·c″ and 4.5≤n≤7.5.

In yet another example, a solid-state ionic conductive material includes perovskite-type oxides such as (Li,La)TiO₃ or doped or replaced compounds.

In yet another example, a solid-state ionic conductive material includes NASICON-structured lithium membrane, such as LAGP (Li₁₋ₓAlₓGe₂₋ₓ(PO₄)₃), LATP (Li₁₊ₓAlₓTi₂₋ₓ(PO₄)₃) and these materials with other elements doped therein.

In yet another example, a solid-state ionic conductive material includes anti-perovskite structure materials and their derivatives, such as the composition of Li₃OCl, Li₃OBr, and Li₃OI.

In yet another example, a solid-state ionic conductive material includes the Li₃YH₆ (H=F, Cl, Br, I) family of materials, Y can be replaced by other trivalent elements.

In yet another example, a solid-state ionic conductive material includes alkali metal halides with the general formula AₐM_{b}^{m+}M′_{b′}^{m′+}X_{a+mb+m′b′}, where A=Li⁺, Na⁺, K⁺, or a combination thereof, X⁻=F⁻, Cl⁻, Br⁻, I⁻, or a combination thereof, M^{m+}=Ti²⁺, V²⁺, Cr²⁺, Mn²⁺, Fe²⁺, Co²⁺, Ni²⁺, Cu²⁺, Zn²⁺, Cd²⁺, Mg²⁺, Pb²⁺, Y³⁺, Sc³⁺, Lu³⁺, La³⁺, Al³⁺, Ga³⁺, In³⁺, Er³⁺, Ho³⁺, Ti³⁺, Cr³⁺, V³⁺, Hf⁴⁺, Zr⁴⁺, V⁴⁺, Ti⁴⁺, Mo⁴⁺, W⁴⁺, V⁵⁺, Nb⁵⁺, Ta⁵⁺, Cr⁶⁺, Mo⁶⁺, W⁶⁺, etc., and M^{′m+} may be metal with the same valance state as M^{m+} when b′ is greater than 0, or an aliovalent substitution when b′ is greater than 0.

A solid-state electrolyte membrane may include a mixture of two or more solid-state ionic conductive materials.

A solid-state ionic conductive material in a solid-state electrolyte layer may be the same solid-state ionic conductive material in the composite cathode layer. Alternatively, a solid-state ionic conductive material in a solid-state electrolyte layer may not be the same solid-state ionic conductive material in the composite cathode layer.

A solid-state ionic conductive material in a solid-state electrolyte layer may be the same solid-state ionic conductive material in the composite anode layer. Alternatively, a solid-state ionic conductive material in a solid-state electrolyte layer may not be the same solid-state ionic conductive material in the composite anode layer.

In some instances, a solid-state electrolyte layer may be a ceramic-polymer composite, composed of a solid-state ionic conductive material and a binding polymer.

A binding polymer may include, for example, polyolefins (e.g., polyethylenes, poly(butene-1), poly(n-pentene-2), polypropylene, polytetrafluoroethylene), polyamines (e.g., poly(ethylene imine) and polypropylene imine (PPI)); polyamides (e.g., polyamide (Nylon), poly(ϵ-caprolactam) (Nylon 6), poly(hexamethylene adipamide) (Nylon 66)), polyimides (e.g., polyimide, polynitrile, and poly(pyromellitimide-1,4-diphenyl ether) (Kapton®) (NOMEX®) (KEVLAR®)); polyether ether ketone (PEEK); vinyl polymers (e.g., polyacrylamide, poly(2-vinyl pyridine), poly(N-vinylpyrrolidone), poly(methylcyanoacrylate), poly(ethylcyanoacrylate), poly(butylcyanoacrylate), poly(isobutylcyanoacrylate), poly(vinyl acetate), poly(vinyl alcohol), poly(vinyl chloride), poly(vinyl fluoride), poly(2-vinyl pyridine), vinyl polymer, polychlorotrifluoro ethylene, and poly(isohexylcynaoacrylate)); polyacetals; polyesters (e.g., polycarbonate, polybutylene terephthalate, polyhydroxybutyrate); polyethers (poly(ethylene oxide) (PEO), poly(propylene oxide) (PPO), poly(tetramethylene oxide) (PTMO)); vinylidene polymers (e.g., polyisobutylene, poly(methyl styrene), poly(methylmethacrylate) (PMMA), poly(vinylidene chloride), and poly(vinylidene fluoride)); polyaramides (e.g., poly(imino-1,3-phenylene iminoisophthaloyl) and poly(imino-1,4-phenylene iminoterephthaloyl)); polyheteroaromatic compounds (e.g., polybenzimidazole (PBI), polybenzobisoxazole (PBO) and polybenzobisthiazole (PBT)); polyheterocyclic compounds (e.g., polypyrrole); polyurethanes; phenolic polymers (e.g., phenol-formaldehyde); polyalkynes (e.g., polyacetylene); polydienes (e.g., 1,2-polybutadiene, cis or trans-1,4-polybutadiene); polysiloxanes (e.g., poly(dimethylsiloxane) (PDMS), poly(diethylsiloxane) (PDES), polydiphenylsiloxane (PDPS), and polymethylphenylsiloxane (PMPS)); and inorganic polymers (e.g., polyphosphazene, polyphosphonate, polysilanes, polysilazanes). In some embodiments, the polymer may be selected from poly(n-pentene-2), polypropylene, polytetrafluoroethylene, polyamides (e.g., polyamide (Nylon), poly(ϵ-caprolactam) (Nylon 6), poly(hexamethylene adipamide) (Nylon 66)), polyimides (e.g., polynitrile, and poly(pyromellitimide-1,4-diphenyl ether) (Kapton®) (NOMEX®) (KEVLAR®)), polyether ether ketone (PEEK).

A ceramic-polymer composition may contain an ionic conducting salt. An example of an ionic conducting salt may include, for example, lithium bis(trifluoromethanesulfonyl)imide (LiTFSI) and lithium bis(fluorosulfonyl)imide (LiFSI), lithium bis(oxalato)borate (LiBOB), lithium Difluro(oxalato)borate (LiDFOB), LiSCN, LiBr, LiI, LiClO₄, LiAsF₆, LiSO₃CF₃, LiSO₃CH₃, LiBF₄, LiB(Ph)₄, LiPF₆, LiC(SO₂CF₃)₃, LiN(SO₂CF₃)₂), LiNO₃, sodium bis(trifluoromethanesulfonyl)imide (NaTFSI) and sodium bis(fluorosulfonyl)imide (NaFSI), sodium bis(oxalato)borate (NaBOB) Sodium-difluoro(oxalato)borate (NaDFOB), NaSCN, NaBr, NaI, NaAsF₆, NaSO₃CF₃, NaSO₃CH₃, NaBF₄, NaPF₆, NaN(SO₂F)₂, NaClO₄, NaN(SO₂CF₃)₂, NaNO₃, magnesium bis(trifluoromethanesulfonyl)imide (Mg(TFSI)₂) and magnesium bis(fluorosulfonyl)imide (Mg(FSI)₂), magnesium bis(oxalato)borate (Mg(BOB)₂), magnesium Difluro(oxalato)borate (Mg(DFOB)₂), Mg(SCN)₂, MgBr₂, MgI₂, Mg(ClO₄)₂, Mg(AsF₆)₂, Mg(SO₃CF₃)₂, Mg(SO₃CH₃)₂, Mg(BF₄)₂, Mg(PF₆)₂, Mg(NO₃)₂, Mg(CH₃COOH)₂, potassium bis(trifluoromethanesulfonyl)imide (KTFSI) and potassium bis(fluorosulfonyl)imide (KFSI), potassium bis(oxalato)borate (KBOB), potassium Difluro(oxalato)borate (KDFOB), KSCN, KBr, KI, KClO₄, KAsF₆, KSO₃CF₃, KSO₃CH₃, KBF₄, KB(Ph)₄, KPF₆, KC(SO₂CF₃)₃, KN(SO₂CF₃)₂), KNO₃, Al(NO₃)₂, AlCl₃, Al₂(SO₄)₃, AlBr₃, AlI₃, AlN, AlSCN, Al(ClO₄)₃.

The present description pertains to inactive components of a next-generation battery.

A negative current collector may be composed of copper foil, copper mesh, carbon-coated copper foil, carbon-coated copper mesh, stainless steel foil, stainless steel mesh, titanium foil, titanium mesh, etc.

A positive current collector may be composed of aluminum foil, aluminum mesh, nickel foil, nickel mesh, etc.

A next-generation battery may comprise an enclosure made of aluminum metal, aluminum pouch, nickel-coated steel hard casings, plastic, stainless steel, and thermoplastic resins, etc.

A next-generation battery may comprise a battery separator comprising, for example, cellulosic, glass mats, polyolefin, polyethylene, polypropylene, etc.

A next-generation battery cell may comprise additional inactive components such as tabs, soldered welds, Kapton tape, terminals, etc.

The present description pertains to a next-generation battery.

A next-generation battery may have one of the following form factors: pouch cell, cylindrical cell, prismatic cell, button cell, coin cell, etc.

A next-generation battery may have a size range of 0.005<s<1200 Ah, with a preferred range of 0.1<s<250 Ah.

A next-generation battery with a cylindrical cell form factor may have one of the following sizes: 07540, 08570, 10180, 10280, 10440, 10850, 13400, 14250, 14300, 14430, 14500, 14650, 15270, 16340, 16650, 17500, 17650, 17670, 18350, 18490, 18500, 18650, 20700, 21700, 25500, 26500, 26650, 26700, 26800, 32600, 32650, 32700, 38120, 38140, 40152, 4680, 4695, 46120.

A next-generation battery with a button or coin form factor may have one of the following sizes: CR927, CR1025, CR1130, CR1216, CR1220, CR1225, CR1616, CR1620, CR1632, CR2012, CR2016, CR2020, CR2025, CR2032, CR2040, CR2050, CR2320, CR2625, CR2330, BR2335, CR2354, CR2412, CR2430, CR2450, CR2477, CR3032, CR11108.

A next-generation battery with a pouch cell form factor may have a single layer or more than one layer termed in the art as a multi-layer cell.

The drawing of the present disclosure further describes the modular dry room system, and the next-generation batteries processed therein.

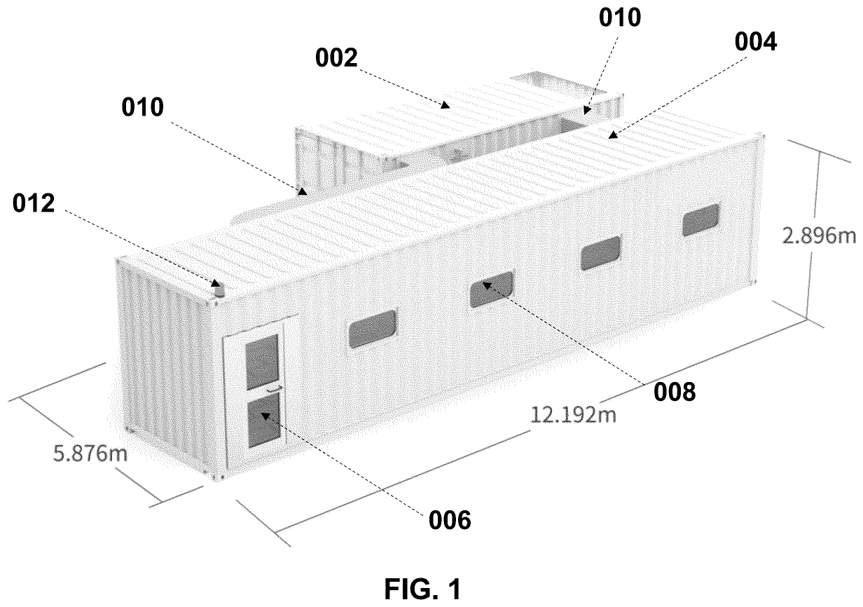

FIG. 1A: A schematic representation of a modular dry room system comprising a control module (002) and a processing module (004). The exterior of the processing module comprises an antechamber entry (006), observation windows (008), and an indicator light (012) for when the processing module is in use. The control module and processing module are connected by an air handling system (010). The schematic illustration depicts a standard modular dry room system of 12.192 meters long, 5.876 meters wide, and 2.896 meters high.

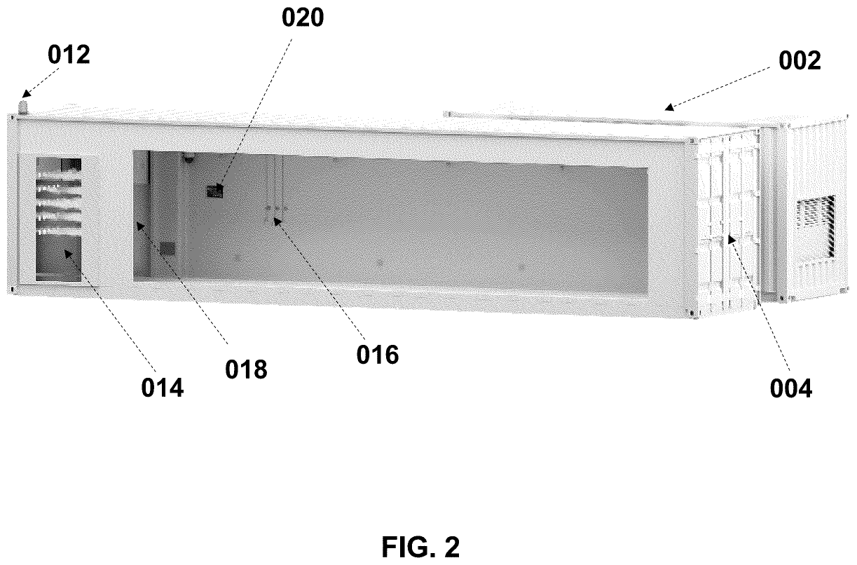

FIG. 2: A schematic representation of a modular dry room system comprising a control module (002) and a processing module (004). The interior of the processing module comprises an antechamber room (014), gas lines (016), an entryway (018) from the antechamber, and an interface panel (020) that communicates with the control module. The interior of the processing module is left empty for simplification.

In addition to the schematic elements shown in FIGS. 1A and 2, a modular dry room system may additionally include structural and functional features that enable secure and efficient interconnection between the control module (002) and the processing module (004). These features may include pre-configured sealed ports, flexible or rigid conduit couplings, and quick-connect fittings for air handling, electrical power, process gas lines, and data communication.

During transport, the control and processing modules may be delivered as independent units, each capable of being secured to a flatbed trailer, railcar, or shipping platform. Upon delivery, the modules may be aligned and interconnected on-site through a coordinated setup process that includes mechanical docking, utility connection, and system validation. Depending on operational needs and site constraints, the modules may be arranged in a side-by-side configuration or stacked vertically using structural frames.

The control module functions as the centralized systems management unit, delivering conditioned air, regulated power, and automated process control to the processing module. Conversely, the processing module serves as the sealed working environment where moisture-sensitive manufacturing operations occur. The interface panel (020) within the processing module enables real-time communication and control with the systems housed in the control module.

In some embodiments, the modular dry room system may be designed to allow a single control module to serve multiple processing modules. Alternatively, a series of modular systems may be deployed in parallel or networked configurations, enabling expansion of manufacturing capacity or redundancy in critical operations. Each module may be pre-tested prior to deployment and undergo post-setup verification, allowing rapid commissioning and scalability.

Thus, although the drawings simplify the depiction of the system, the modular dry room system may include sophisticated interconnection features that support flexible installation, integrated system control, and deployment in a variety of industrial and non-traditional environments.

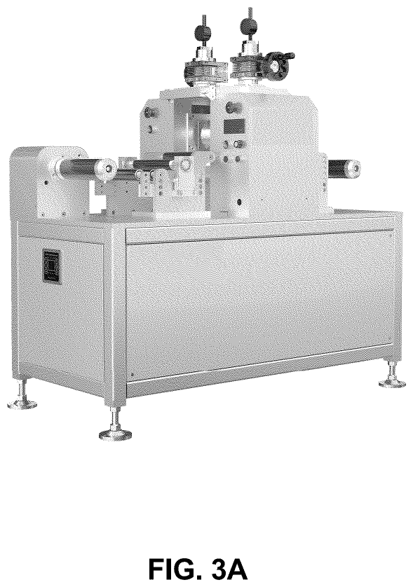

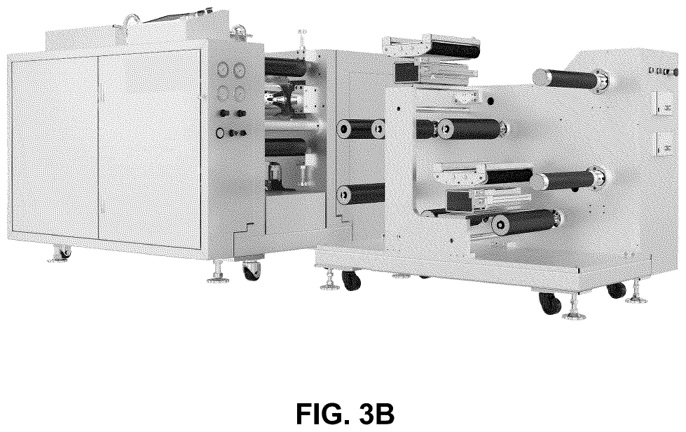

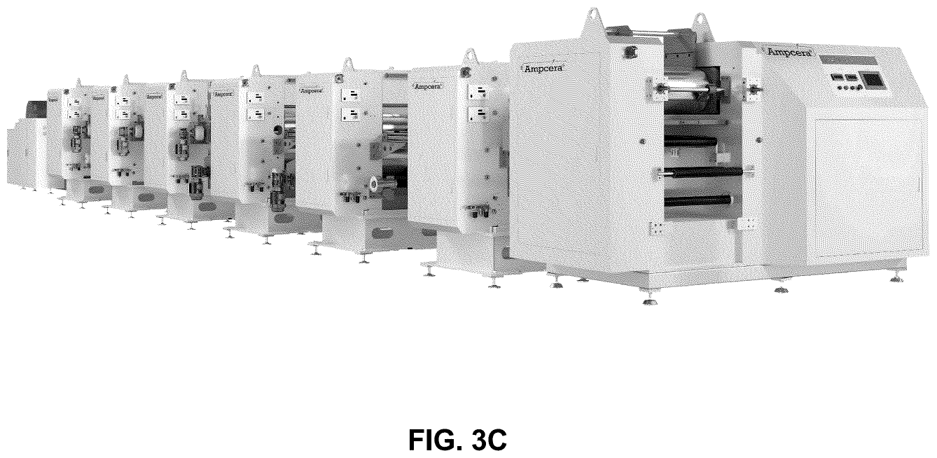

FIG. 3A: A schematic representation of a two-roller calendering system used in dry manufacturing of next-generation batteries. Such systems may be incorporated in the processing module. A two-roller calendering system may be used for manufacturing at the research and development level.

FIG. 3B: A schematic representation of a four-roller calendering system used in dry manufacturing of next-generation batteries. Such systems may be incorporated in the processing module. A four-roller calendering system may be used for manufacturing at the pre-pilot level.

FIG. 3C: A schematic representation of a multi-roller calendering system used in dry manufacturing of next-generation batteries. Such systems may be incorporated in the processing module. A multi-roller calendering system may be used for manufacturing at the pilot and mass production levels.

These figures reflect the scalability of the calendering process within the modular dry room environment, wherein progressively more complex and higher-capacity roller configurations may be installed depending on production stage and throughput requirements. The two-roller system may be compact and suitable for benchtop installation within a smaller processing module footprint, while the four-roller and multi-roller systems may require more robust structural integration directly onto the modular floor.

Although the figures illustrate roller systems at different production levels, the core purpose remains consistent—to apply heat and pressure to densify and smooth freestanding films. These systems may include heated rollers with adjustable temperature profiles, programmable roller gaps, and embedded sensors for real-time thickness and temperature monitoring. The control module may be configured to operate each roller set via the central interface panel, adjusting parameters dynamically to maintain process uniformity.

In addition to the core components shown, calendering systems may further include pre-feed tensioners, web guiding systems, substrate unwind and rewind spools, and safety enclosures with interlocks. While these auxiliary systems are not shown in the figures, they may be incorporated depending on the application and integration level.

The roller systems may also be equipped with modular mounting brackets or vibration-dampening bases to stabilize operation and minimize disturbance to nearby sensitive equipment. In full-scale configurations, the multi-roller calendering system may be directly connected to adjacent stages, such as omnidirectional film deposition (upstream) and slitting (downstream), via enclosed roll-to-roll paths that preserve environmental integrity and prevent moisture ingress.

Thus, the roller configurations shown in FIGS. 3A-3C underscore the modular dry room system's ability to support varying scales of dry-based processing within a common architectural framework, enabling streamlined progression from research to commercial-scale production using interchangeable equipment sets.

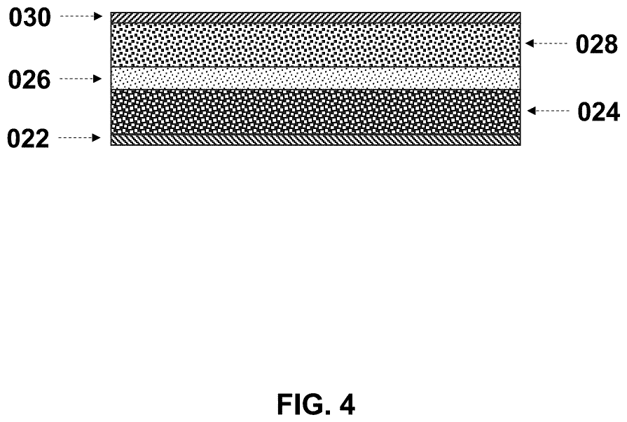

FIG. 4: A schematic representation of a sulfide-based solid-state battery. A solid-state battery comprises a composite cathode (024), a positive current collector (022), a solid-state electrolyte membrane (026), a composite anode (028), and a negative current collector (030). The composite cathode (024) and composite anode (028) further comprise ionic conducting solid-state electrolytes in the form of a catholyte and anolyte, respectively.

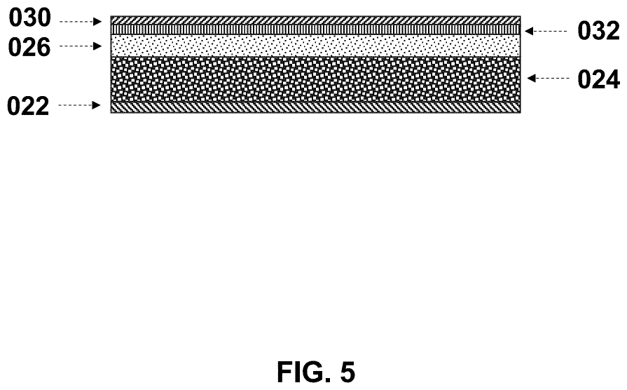

FIG. 5: A schematic representation of a sulfide-based solid-state battery. A solid-state battery comprises a composite cathode (024), a positive current collector (022), a solid-state electrolyte membrane (026), an alkali-metal anode (032), and a negative current collector (030). The composite cathode (024) further comprises an ionic conducting solid-state electrolyte in the form of a catholyte.

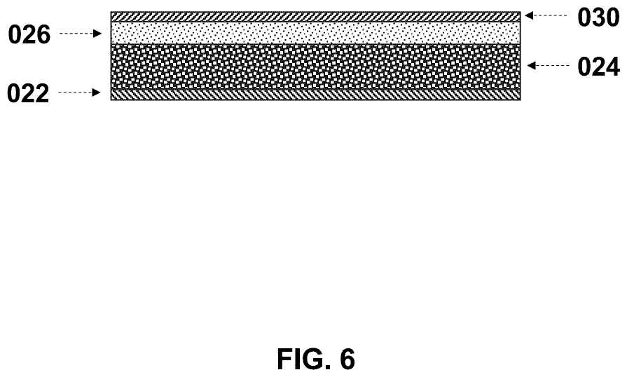

FIG. 6: A schematic representation of a sulfide-based solid-state battery. A solid-state battery comprises a composite cathode (024), a positive current collector (022), a solid-state electrolyte membrane (026), and a negative current collector (030). The composite cathode (024) further comprises an ionic conducting solid-state electrolyte in the form of a catholyte.

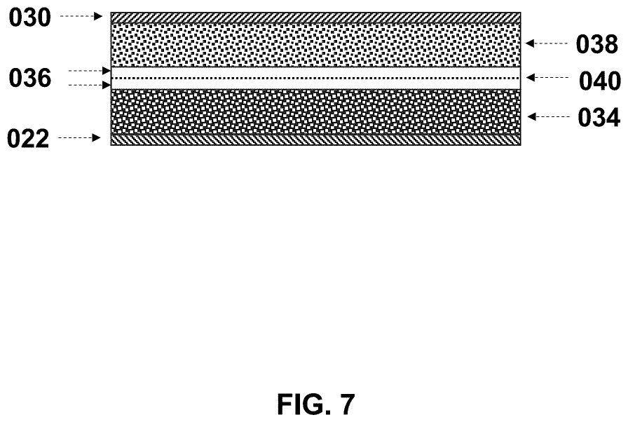

FIG. 7: A schematic representation of a lithium battery. A lithium battery comprises a cathode (034), a positive current collector (022), a liquid electrolyte (036), a porous separator (040), an anode (038), and a negative current collector (030).

The schematic illustrations in FIGS. 4-7 provide a comparative overview of battery architectures relevant to next-generation and conventional systems. FIGS. 4-6 emphasize various configurations of sulfide-based solid-state batteries, while FIG. 7 illustrates a traditional lithium-ion battery employing a liquid electrolyte and porous separator.

The progression from FIG. 4 to FIG. 6 demonstrates the modularity and versatility of sulfide-based solid-state designs. These batteries may be tailored with composite or alkali-metal anodes depending on performance targets such as energy density, interfacial stability, and manufacturability. The use of composite cathodes and anodes containing catholyte and anolyte regions, as shown in FIG. 4, may provide improved ionic pathways, mechanical robustness, and seamless integration with the solid-state electrolyte membrane.

In contrast, FIG. 7 serves as a reference for conventional lithium-ion battery construction, highlighting key differences such as the presence of a liquid electrolyte and a porous separator, which are generally avoided in sulfide-based solid-state battery designs due to their inherent flammability, moisture sensitivity, and limitations on thermal stability.

Although these figures are simplified for clarity, the internal microstructure of each electrode and electrolyte layer may include additional features such as gradient material compositions, reinforcing fibers, binder networks, or interfacial coatings to improve conductivity, adhesion, or cycling performance. These enhancements may be processed within the modular dry room system using the wet-based or dry-based processing routes described earlier.

Moreover, while not depicted in the schematic illustrations, additional elements such as current interrupt devices, gas detection sensors, or thermal management features may be included in assembled battery cells to meet specific safety or performance requirements, particularly for sulfide-based chemistries prone to hydrogen sulfide formation.

The batteries represented in FIGS. 4-7 may be fabricated entirely or partially within the modular dry room system depending on system configuration, desired throughput, and environmental constraints. The flexible architecture of the system supports batch or continuous processing for diverse battery formats, including pouch, prismatic, or coin cell types.

The above-described systems and methods can be ascribed to the next-generation batteries with chemistries beyond lithium, which may include sodium ion, aluminum ion, magnesium ion, iron ion, potassium ion, etc.

The above-described systems and methods can be ascribed to next-generation batteries of various form factors such as button, coin, pouch button, pouch coin, pouch, prismatic, or cylindrical cells.

The above-describes system and methods can be ascribed to various types of next-generation batteries including, for example, hybrid solid-state batteries, semi-hybrid solid-state batteries, lithium metal batteries, hybrid lithium metal batteries, semi-hybrid lithium metal batteries, anodeless batteries, anodeless lithium metal batteries, hybrid anodeless lithium metal batteries, semi-hybrid anodeless lithium metal batteries, lithium-air batteries, lithium primary batteries, microbatteries, thin film batteries, lithium-sulfur batteries, etc.

The above-described systems and methods can be ascribed to next-generation batteries for all types of electric vehicles including, but not limited to, sedan, coupe, convertible, hatchback, support utility, sports, compact, subcompact, minivan, van, luxury, truck, full-size truck, pickup truck, economy, crossover, wagon, full-size, mix-size, bus, semi, etc.

The above-described systems and methods can be ascribed to next-generation batteries with the end use applications other than electric vehicles such as, for example, hybrid electric vehicles, mobile devices, handheld electronics, consumer electronics, medical, medical wearables, and wearables for portable energy storage.

The above-described systems and methods can be ascribed to next-generation batteries for grid-scale energy storage backup systems.

The above-described systems and methods can be ascribed to next-generation batteries for longevity, higher energy density and power density, enhanced performance, and improved safety.

The above-described systems and methods can be ascribed to next-generation battery technologies such as primary solid-state batteries and solid-state flow batteries.

The above-described systems and methods can be ascribed to next-generation batteries used in locations other than the vicinity of Earth including in space, such as space stations, satellites, both natural and unnatural, and other planetary bodies such as Mars.

The above-described systems and methods can be ascribed to modular dry room systems for the manufacturing of non-battery-related materials and components such as for example, pharmaceuticals, food processing, food packaging, etc. A modular dry room system may be used for the manufacturing of any moisture-sensitive material and components of any industry and is thus not limited to the battery industry.

In the drawings, the following reference numbers are noted:
002 Control module
004 Processing module
006 Antechamber entry
008 Observation window
010 Air handling system
012 Indicator light
014 Antechamber room
016 Gas lines
018 Entryway into processing module
020 Interface panel
022 Positive current collector
024 Composite cathode
026 Solid-state electrolyte membrane
028 Composite anode
030 Negative current collector
032 Alkali-metal anode
034 Cathode
036 Liquid electrolyte
038 Anode
040 Porous separator

Although the foregoing description primarily illustrates embodiments in which the processing module is configured for battery manufacturing, it will be understood that the modular dry room system is not limited to production-scale operations. In other embodiments, the processing module may be configured for other types of processing, including assembly of battery components into complete battery cells or packs, disassembly of battery cells or packs for purposes such as failure analysis, component evaluation, or recycling, repair or refurbishment of battery components, recovery of active materials from electrodes, research and development activities involving experimental battery chemistries or architectures, and testing or conditioning of cells or components under controlled environmental conditions. These variations may be implemented without departing from the scope of the present description, and references to processing herein are intended to encompass all such activities, whether conducted at laboratory, pilot, or production scale.

Although various embodiments of the disclosure of the dry room modules have been shown and described, modifications may occur to those skilled in the art upon reading the specification. The present description includes such modifications and is limited only by the scope of the claims.

In addition to the embodiments described herein, it should be understood that other variations, modifications, and adaptations may be made by those skilled in the art without departing from the scope and spirit of the invention as defined by the appended claims. The present disclosure is intended to cover any and all such variations and is not limited to the specific embodiments provided herein.

The terminology used in the description is not intended to be limiting or construed in a restrictive manner. The terms used are intended to be descriptive and illustrative, and it should be understood that the scope of the invention is not limited by the specific examples or descriptions provided.

Furthermore, while certain aspects of the invention have been illustrated and described in detail, it should be understood that the invention is not limited to the specific features, configurations, or relative proportions set forth. Instead, various modifications and combinations of features, configurations, and relative proportions are envisioned within the scope of the appended claims.

In the event that the disclosure includes any inconsistencies or conflicts between the present specification, the abstract, and/or the claims, it is hereby expressly stated that any such inconsistencies or conflicts shall be resolved in favor of the broader, more general interpretation, and that any narrowing of the scope of the claims or other interpretations inconsistent with the broader interpretation shall be disregarded.

The embodiments described herein are intended to be illustrative and not restrictive. Other variations, modifications, and adaptations will be apparent to those skilled in the art upon reviewing the disclosure, and the scope of the invention should be determined with reference to the appended claims, along with the full range of equivalents to which the claims are entitled.

What is claimed is:

1. A modular dry room system comprising:
a processing module configured to perform one or more moisture-sensitive processes; and
a control module physically separate from and operatively connected to the processing module, wherein the control module is configured to monitor and regulate environmental conditions within the processing module.

2. The modular dry room system of claim 1, wherein the control module comprises a primary air handling system configured to supply dehumidified air to the processing module.

3. The modular dry room system of claim 1, wherein the processing module is hermetically sealed and configured to maintain an internal dew point of less than −40° C.

4. The modular dry room system of claim 1, wherein the control module comprises an air handling system configured to supply dehumidified air to the processing module.

5. The modular dry room system of claim 1, wherein the control module further comprises a solvent recycling system configured to recover solvent vapor from the processing module.

6. The modular dry room system of claim 4, wherein the solvent recycling system comprises a chilling system for condensing solvent vapor into liquid.

7. The modular dry room system of claim 1, wherein the processing module comprises a hydrogen sulfide gas neutralization system comprising a heated copper-based medium.

8. The modular dry room system of claim 6, wherein the hydrogen sulfide gas neutralization system comprises a porous compartment containing a high surface area copper or copper oxide powder.

9. A method of installing a modular dry room system, the method comprising:
providing a processing module configured to perform one or more moisture-sensitive processes; and
connecting a control module to the processing module, wherein the control module is physically separate from the processing module and is operatively connected to monitor and regulate environmental conditions within the processing module

10. The method of claim 9, wherein connecting the control module to the processing module comprises connecting an air handling system configured to supply dehumidified air to the processing module.

11. The method of claim 9, wherein connecting the control module to the processing module comprises connecting a power distribution system to supply power to equipment housed in the processing module.

12. The method of claim 9, further comprising transporting the processing module and control module separately to an installation site.

13. The method of claim 12, wherein the processing module and control module are delivered by flatbed trailer or railcar.

14. The method of claim 9, further comprising activating a hydrogen sulfide gas neutralization system within the processing module.

15. The method of claim 9, further comprising activating a solvent recycling system within the control module to recover solvent vapor from the processing module.

16. The method of claim 9, wherein the control module and processing module are configured to begin operation without on-site panel assembly or dry room construction.

17. A method for processing a battery using a modular dry room system comprising a processing module and a physically separate control module operatively connected thereto, the method comprising:
regulating environmental conditions within the processing module using the control module; and
performing one or more moisture-sensitive battery processing steps within the processing module.

18. The method of claim 17, wherein the regulated environmental conditions include maintaining a dew point below −40° C. within the processing module.

19. The method of claim 17, wherein the battery is a sulfide-based solid-state battery.

20. The method of claim 17, wherein performing one or more moisture-sensitive battery processing steps comprises at least one of assembling battery components into a battery, disassembling a battery to evaluate or recover components, or processing battery materials to form at least a portion of a battery component within the processing module.
